(19) United States
(12) Patent Application Publication
(10) Pub. No.: US 2015/0079316 A1
(43) Pub. Date: Mar. 19, 2015

(54) ELONGATED FASTENERS FOR RETAINING INSULATION WRAPS AROUND ELONGATED CONTAINERS, SUCH AS PIPES, SUBJECT TO TEMPERATURE FLUCTUATIONS, AND RELATED COMPONENTS AND METHODS

(71) Applicants: Teresa Ann Pernell, Franklinton, NC (US); Joseph Robert Secoura, Wake Forest, NC (US)

(72) Inventors: Teresa Ann Pernell, Franklinton, NC (US); Joseph Robert Secoura, Wake Forest, NC (US)

(73) Assignee: NOMACO INC., Zebulon, NC (US)

(21) Appl. No.: 14/488,953

(22) Filed: Sep. 17, 2014

Related U.S. Application Data
(60) Provisional application No. 61/878,923, filed on Sep. 17, 2013.

(51) Int. Cl. F16L 59/02; F16L 59/14; F16B 2/20

(52) U.S. Cl. CPC F16L 59/028; F16B 2/20; F16L 59/143; F16L 59/027
USPC 428/34.1; 24/570; 138/158

(57) ABSTRACT

An elongated fastener is configured to retain an insulation wrap around an elongated container. The fastener includes an elongated and substantially flat fastener body having first and second parallel rails extending from each longitudinal side of the fastener body. The fastener body is configured to span an elongated seam formed by opposing sides of the insulation wrap when the joint is disposed around the elongated container. Each rail is configured to extend into a complementary longitudinal slot disposed at an edge of a respective opposing side of the insulation wrap. Each rail includes at least one protrusion for engaging with each slot, thereby retaining each rail in its respective slot and retaining the insulation wrap around the elongated container.

### PRIORITY APPLICATION

The present application claims priority to U.S. Provisional Patent Application Ser. No. 61/878,923 filed on Sep. 17, 2013 entitled “Elongated Fasteners for Retaining Insulation Wraps Around Elongated Containers, Such as Pipes, Subject to Temperature Fluctuations, and Related Components and Methods,” which is incorporated herein by reference in its entirety.

### RELATED APPLICATION

The present application is related to U.S. patent application Ser. No. 13/892,614 filed on May 13, 2013 entitled “Insulation Systems Employing Expansion Features to Insulate Elongated Containers Subject to Extreme Temperature Fluctuations, and Related Components and Methods,” which is incorporated herein by reference in its entirety.

### FIELD OF DISCLOSURE

The field of the disclosure relates to elongated fasteners for insulators and insulation products to provide insulation, including but not limited to pipes, tanks, vessels, etc. As a non-limiting example, the insulators and fasteners may be used with pipes that transport temperature-sensitive liquids such as petroleum, ammonia, liquid carbon dioxide, and natural gas.

### BACKGROUND

Benefits of elongated containers, such as pipes, include their ability to transport very large quantities of liquids from a liquid source to one or more destination points. Pipes may be the transportation method of choice when extremely large quantities of liquids are desired to be continuously moved. The liquids being transported through the pipe may be phase-sensitive, meaning that the liquids may change to a solid or vapor within a range of ambient temperatures expected for the environment where the pipe will be located. The liquids transported through the pipe may also be viscosity-sensitive, meaning that the liquids may change viscosity within the range of ambient temperatures.

In this regard, heaters and/or coolers may be placed within the pipe to heat or cool a temperature of the liquid to ensure that the liquid stays within an acceptable temperature range to ensure a proper phase and viscosity during transportation thorough the pipe. An amount of energy needed for operation of the heaters and coolers may be reduced by insulating an external surface of the pipe. Typical insulations contact the external surface of the pipes, tanks, vessels, etc., and serve to reduce thermal energy loss by providing insulation properties around the exterior surfaces thereof.

Insulation members may be attached in segments along the length of a pipe. The insulation members may thermally change dimensions as contents of the pipe and/or ambient temperature fluctuate. In this manner, unwanted openings may form between insulation members as dimensions thermally change so that portions of the pipe may be without insulation at the unwanted openings, and thus piping system malfunctions or unwanted energy expenses may occur. Furthermore, unwanted openings between the insulation members may allow excessive moisture to collect between the pipe and the insulation members, and thus the excessive moisture may damage the pipe or significantly reduce the insulating properties of the insulation members. What is needed is an efficient and reliable insulation system to be used for elongated containers, such as pipes subjected to extreme temperature fluctuations.

### SUMMARY OF THE DETAILED DESCRIPTION

Embodiments disclosed herein include an elongated fastener for retaining an insulation wrap around an elongated container. In one embodiment, the fastener includes an elongated and substantially flat fastener body having first and second parallel rails extending from each longitudinal side of the fastener body. The fastener body is configured to span an elongated seam formed by opposing sides of the insulation wrap when the joint is disposed around the elongated container. Each rail is configured to extend into a complementary longitudinal slot disposed at an edge of a respective opposing side of the insulation wrap. Each rail includes at least one protrusion for engaging with each slot, thereby retaining each rail in its respective slot and retaining the insulation wrap around the elongated container. By securing the entire length of the seam, the elongated fastener can prevent excessive stress from being applied to portions of the insulation wrap.

In one exemplary embodiment, an elongated fastener for retaining an insulation wrap around an elongated container is disclosed. The fastener comprises a substantially flat fastener body. The fastener body is configured to extend along at least one seam formed by first and second longitudinal sides of the insulation wrap when the insulation wrap is disposed around the elongated container. The fastener body is further configured to span the at least one seam, the fastener body having a first longitudinal edge and a second longitudinal edge. The fastener also comprises a first rail extending from the first longitudinal edge of the fastener body. The first rail is configured to be inserted into a first longitudinal slot in the insulation wrap extending proximate to and parallel to the first longitudinal side. The first rail has at least one protrusion for engaging an interior surface of the first longitudinal slot, thereby retaining the first rail in the first longitudinal slot. The fastener also comprises a second rail extending from the second longitudinal edge of the fastener body. The second rail is configured to be inserted into a second longitudinal slot in the insulation wrap extending proximate to and parallel to the second longitudinal side. The second rail has at least one protrusion for engaging an interior surface of the second longitudinal slot, thereby retaining the second rail in the second longitudinal slot.

In another exemplary embodiment, a method of retaining an insulation wrap around an elongated container is disclosed. The method comprises disposing an insulation wrap around an elongated container extending in a longitudinal direction such that a first longitudinal side of the insulation wrap is disposed adjacent to a second longitudinal side of the insulation wrap, thereby forming at least one seam along a longitudinal direction. The method further comprises fastening the first and second longitudinal sides of the insulation wrap via an elongated fastener. The fastener comprises a substantially flat fastener body configured to extend along the at least one seam. The fastener body has a first longitudinal edge and a second longitudinal edge. The fastener further comprises a first rail extending from the first longitudinal edge of the fastener body. Fastening the first and second longitudinal sides includes inserting the first rail into a first longitudinal slot in the insulation wrap extending proximate to and parallel to the first longitudinal side. The first rail has at least one protrusion engaging an interior surface of the first longitudinal slot, thereby retaining the first rail in the first longitudinal slot. The fastener further comprises a second rail extending from the second longitudinal edge of the fastener body. Fastening the first and second longitudinal sides includes inserting the second rail into a second longitudinal slot in the insulation wrap extending proximate to and parallel to the second longitudinal side. The second rail has at least one protrusion engaging an interior surface of the second longitudinal slot, thereby retaining the second rail in the second longitudinal slot.

In another exemplary embodiment, an insulation system for an exterior of an elongated container is disclosed. The insulation system includes an insulation wrap configured to be disposed around an elongated container. The insulation wrap extends from a first longitudinal side to a second longitudinal side opposite the first longitudinal side. The insulation wrap extends from the first longitudinal side to the second longitudinal side opposite the first longitudinal side. The insulation wrap further comprises a first longitudinal slot in the insulation wrap extending proximate to and parallel to the first longitudinal side. The insulation wrap further comprises a second longitudinal slot in the insulation wrap extending proximate to and parallel to the second longitudinal side. The insulation wrap further comprises at least one seam extending from the first longitudinal side to the second longitudinal side. The system further comprises at least one longitudinal fastener configured to fasten the first longitudinal side proximate to the second longitudinal side to secure the insulation wrap in a shape or substantially the shape of a cross-sectional perimeter of the elongated container. The at least one longitudinal fastener comprises a substantially flat fastener body configured to extend along the at least one seam and further configured to span the at least one seam, the fastener body having a first longitudinal edge and a second longitudinal edge. The fastener further comprises a first rail extending from the first longitudinal edge of the fastener body and configured to be inserted into the first longitudinal slot, the first rail having at least one protrusion for engaging an interior surface of the first longitudinal slot, thereby retaining the first rail in the first longitudinal slot. The fastener further comprises a second rail extending from the second longitudinal edge of the fastener body and configured to be inserted into the second longitudinal slot, the second rail having at least one protrusion for engaging an interior surface of the second longitudinal slot, thereby retaining the second rail in the second longitudinal slot.

Different materials can be used for the longitudinal fasteners and insulation products disclosed herein. Non-limiting examples of thermoplastic materials that can be used for the longitudinal fasteners and insulation products include polypropylene, polypropylene copolymers, polystyrene, polyethylenes, ethylene vinyl acetates (EVAs), polyolefins, including metallocene catalyzed low density polyethylene, thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and the like, and derivatives thereof. The density of the thermoplastic materials may be provided to any density desired to provide the desired resiliency and expansion characteristics.

Non-limiting examples of thermoset materials that can be used for the longitudinal fasteners and insulation products include polyurethanes, natural and synthetic rubbers, such as latex, silicones, EPDM, isoprene, chloroprene, neoprene, melamine-formaldehyde, and polyester, and derivatives thereof. The density of the thermoset material may be provided to any density desired to provide the desired resiliency and expansion characteristics. The thermoset material can be soft or firm depending on formulations and density selections. Further, if the thermoset material selected is a natural material, such as latex for example, it may be considered biodegradable.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF FIGURES

FIG. 1A is a cutaway close-up side view of an exemplary first embodiment of an insulation system disposed around an elongated container, the insulation system including insulation members and an exemplary foam expansion joint disposed between the insulation members, illustrating at least one channel and inner passageway of the foam expansion joint;

FIG. 1B is a cutaway close-up side view of the expansion joint of the insulation system of FIG. 1A under tension, wherein the insulation members thermally shrink and pull upon the expansion joint, thereby causing expansion of the expansion joint;

FIGS. 2A and 2B depict a perspective view of a substantially non-expandable insulation wrap as known in the art disposed around the elongated container at a datum ambient temperature and at a reduced temperature, respectively, showing a longitudinal fastener failing at the reduced temperature;

FIGS. 3A and 3B depict perspective views of an example of an expandable insulation wrap being disposed around the elongated container during installation at a datum temperature, and when the expandable insulation wrap is expanded to complete the installation, respectively;

FIG. 4 depicts a perspective view of an example of an insulation wrap having an elongated fastener along a seam thereof, thereby retaining opposite longitudinal sides of the insulation wrap together;

FIGS. 5A-5C depict perspective views of an example of a first insulation wrap disposed and fastened around an elongated container, and a second insulation wrap disposed and fastened around the first insulation wrap;

FIG. 6 is a detailed perspective view of a portion of the example of FIG. 5C depicting structural details of the elongated fastener;

FIG. 7 is a cross-sectional view of the example of FIG. 5C illustrating the offset rotational arrangement of the first and second insulation wraps and associated fasteners.

FIGS. 8A-8C are perspective side views of the insulation system of FIG. 1A installed upon a pipe, illustrating respectively, the insulation system with the expansion joint hidden, the expansion joint disposed between the insulation members, and a partial cutaway of the expansion joint;

FIGS. 9A and 9B are side views depicting the insulation members and the expansion joint of FIG. 1A as an external surface of the elongated container reaches an ambient temperature and the operating temperature, respectively;

FIGS. 10A-10D are perspective side views of the expansion joint of FIG. 1A being installed to be part of the insulation system, illustrating respectively, the insulation system before the expansion joint is installed, the expansion joint installed by being disposed between the insulation members, and a partial cutaway of the expansion joint after installation as part of the insulation system;

FIGS. 11A and 11B are a perspective view and a side view, respectively, of an alternative example of an expansion joint which is partially assembled and fully assembled;

FIGS. 11C and 11D are a perspective view and a side view of another embodiment of an expansion joint, comprising a first section attached to an end section with an alternative attachment member, thereby illustrating inner channels, outer channels, and inner passageways;

FIG. 11E depicts a perspective view of an expansion joint that may be another example of the expansion joint of FIG. 8B;

FIG. 12A is a perspective view of another example of an expansion joint extruded and then wound upon a spool for convenient non-factory installations, to become part of an insulation system;

FIGS. 12B-12D are perspective views of process steps to install the expansion joint of FIG. 12A upon an elongated container;

FIG. 12E is a cross-section perspective view of the expansion joint of FIG. 12A;

FIGS. 13A-13C depict a side view during installation, a side view after installation, and a partial perspective view of an expansion joint. respectively, which may be another example of the expansion joint of FIG. 8B;

FIG. 14 shows an exemplary product forming system in the prior art that may be utilized for forming the expansion member of FIG. 13C;

FIGS. 15A and 15B depict perspective views of another embodiment of an expansion joint, comprising a first insulation section with a helical shape and a second insulation section in a helical shape, to ensure the gap between the insulation members is fully insulated, illustrating different material performances wherein the second insulation section is more flexible than the first insulation section;

FIG. 15C is a side view of the expansion joint of FIG. 15A in an uncompressed state, illustrating the helical shape of the first insulation section and the helical shape of the second insulation section;

FIGS. 15D and 15E are perspective views of the expansion joint of FIG. 15C, illustrating end surfaces of the expansion joint after cutting at two different lengths, respectively, as part of an exemplary manufacturing process, to illustrate forming a planar surface at the end surfaces which may provide a continuous surface to abut against the abutment surfaces of the insulation members of FIG. 8B;

FIGS. 16A-16C depict an exemplary process for creating the expansion joint of FIG. 15A;

FIG. 17 depicts a side view of the first insulation section showing a relationship between a diameter, a distance parallel to a center axis of a spiral convolution, and a pitch angle;

FIGS. 18A and 18B are perspective views of two other examples of first insulation sections, illustrating the helical pitch angle will vary inversely with diameter for an identical dimension;

FIGS. 19A and 19B are top perspective views of one embodiment of an expansion joint including a single foam profile, and another expansion joint including a dual profile;

FIGS. 20A and 20B are top perspective views of the expansion joint of FIG. 19B after thermal bonding, and after cutting to form end faces, respectively, illustrating the end faces comprised of a portion of the foam profile and a portion of the second foam profile;

FIG. 20C is a perspective view of a expansion joint installed upon the pipe, illustrating the end faces available to abut against the insulation members of FIG. 8A;

FIG. 21A is a perspective view of another example of an expansion joint installed around the pipe, depicting multiple foam profiles creating end faces with smooth and uniform end faces;

FIG. 21B depicts a perspective view of the expansion joint of FIG. 20C, illustrating the end faces that are different from the end faces in FIG. 21A;

FIGS. 21C-21E are additional perspective views of the expansion joint of FIG. 21A including before cutting to form the end faces, after forming the end faces, and after installation on the pipe, respectively;

FIGS. 22A and 22B are perspective views of another embodiment of an expansion joint before end faces are formed and after the end faces are formed, respectively, illustrating smoother end faces in the absence of the inner passageways;

FIGS. 23A and 23B are side views of another example of an expansion joint which is compressed to close or substantially close the outer channels, inner channels, and inner passageways and is then annealed to hold that compressed position;

FIG. 23C is a perspective view of a soda straw after being pulled to an elongated state and a soda straw compressed back to its original state, respectively, illustrating a mechanical analogy to the expansion joint of FIGS. 23A-23B;

FIGS. 24A and 24B are perspective views of the expansion joint shown in FIG. 13A in an expanded and a compressed state, respectively, illustrating the expansion joint;

FIG. 24C is a perspective view of a metal spring, which is a mechanical analogy to the expansion joint of FIG. 24A;

FIG. 25 is a perspective view of expansion joints formed by annealing the expansion joint of FIG. 20B in a compressed state;

FIG. 26A is an exemplary foam member with pinning or puncturing holes added to provide enhanced compressibility, illustrating a technique to more easily change a shape of expansion joints to fill the gap between the insulation members of FIG. 8A;

FIG. 26B is a perspective view of exemplary expansion joints comprising the pinning or the puncturing holes of FIG. 26A from the external surface to a predetermined depth of the expansion joint, providing enhanced ability for the shape of expansion joints to change to thereby fill the gap between the insulation members of FIG. 8A;

FIGS. 27A-27C are a perspective view, a partial cutaway perspective view, and a full cutaway view, respectively, of an exemplary expansion joint installed upon the pipe, the expansion joint comprising a helical spring disposed within a foam expansion body; and

FIGS. 28A and 28B depict exemplary processes for creating the expandable insulation wrap.

### DETAILED DESCRIPTION

Embodiments of the disclosure include an elongated fastener for retaining an insulation wrap around an elongated container. The fastener includes an elongated and substantially flat fastener body having first and second parallel rails extending from each longitudinal side of the fastener body. The fastener body is configured to span an elongated seam formed by opposing sides of the insulation wrap when the joint is disposed around the elongated container. Each rail is configured to extend into a complementary longitudinal slot disposed at an edge of a respective opposing side of the insulation wrap. Each rail includes at least one protrusion for engaging with each slot, thereby retaining each rail in its respective slot and retaining the insulation wrap around the elongated container. By securing the entire length of the seam, the elongated fastener can prevent excessive stress from being applied to portions of the insulation wrap.

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

It is noted that the expansion features comprise a combination of geometric and material features provided as part of the insulation system to provide a precise stiffness to allow the insulation system to respond when subjected to extreme temperature fluctuations. Geometric features may include, for example, channels (grooves), hinges, arcs, notches, cut segments, cell-size, foam density, and/or inner pathways.

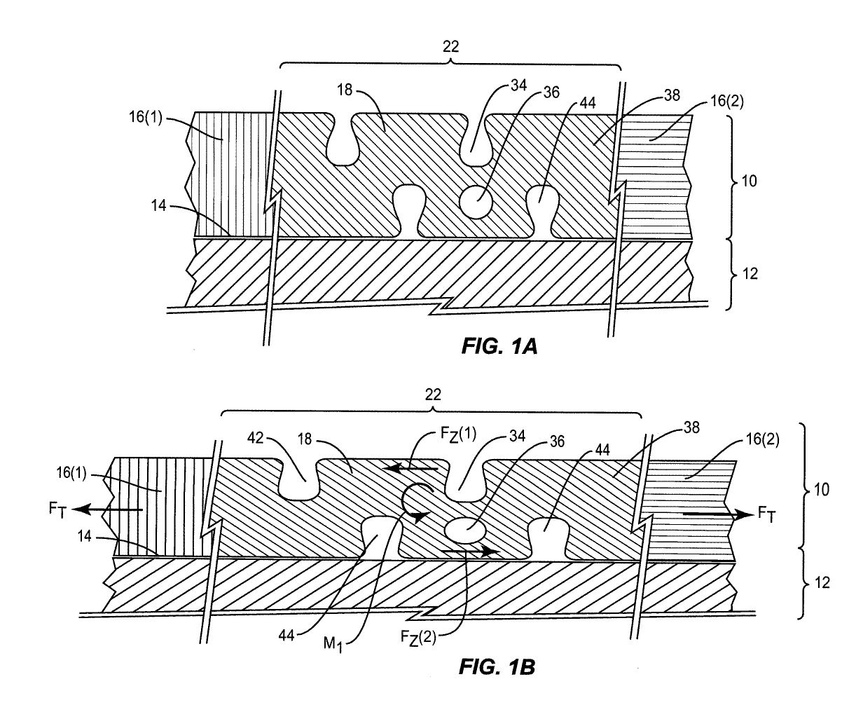

In order to illustrate the fundamental concepts of this disclosure, FIGS. 1A and 1B are cutaway views of an exemplary insulation system 10 disposed proximate to an external surface 14 of an elongated container 12, wherein the insulation system 10 is subject to a datum temperature and a lower temperature, respectively. The insulation system 10 may comprise an expansion joint 18 disposed in a gap 22 between insulation members 16(1), 16(2). The insulation members 16(1), 16(2) have a thermal expansion coefficient wherein they expand parallel to the external surface 14 of the elongated container 12 when subject to temperature increases, and they contract parallel to the external surface 14 when subject to decreasing temperatures. Accordingly, the gap 22 thermally changes dimensions. The elongated container 12 will be efficiently insulated when the gap 22 is fully occupied by the expansion joint 18.

The expansion joint 18 has several features to enable the gap 22 to be efficiently insulated. The expansion joint 18 comprises a foam expansion body 38 made of foam, for example, thermoplastic and/or thermoset, to provide insulation performance to the elongated container 12. The expansion joint 18 may also comprise one or more expansion features comprising at least one inner channel 44, at least one outer channel 34, and/or at least one inner passageway 36, which are configured to change shape when subject to forces F_{T} from the insulation members 16(1), 16(2). The changing shape of these expansion features better enables the expansion joint 18 to fill the gap 22 between the insulation members 16(1), 16(2).

With continued reference to FIGS. 1A and 1B, it is noted that the outer channels 34 and the inner channels 44 may be positioned in a staggered arrangement along the external surface 14. The staggered arrangement in combination with the forces F_{T} from the insulation members 16(1), 16(2) create non-aligned internal forces Fz(1), Fz(2) forming at least one force moment M₁ which enables the expansion joint 18 to further change shape to fill the gap 22 between the insulation members 16(1), 16(2).

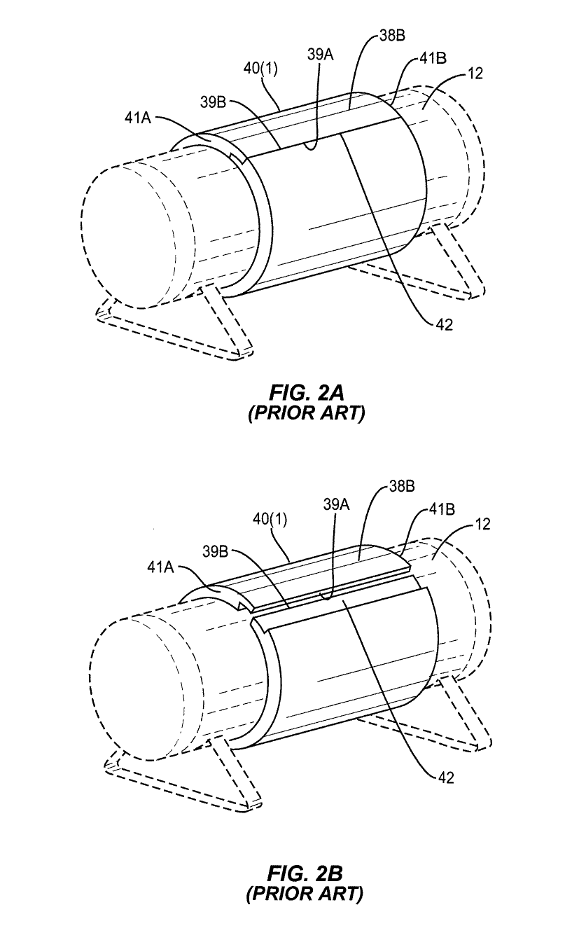

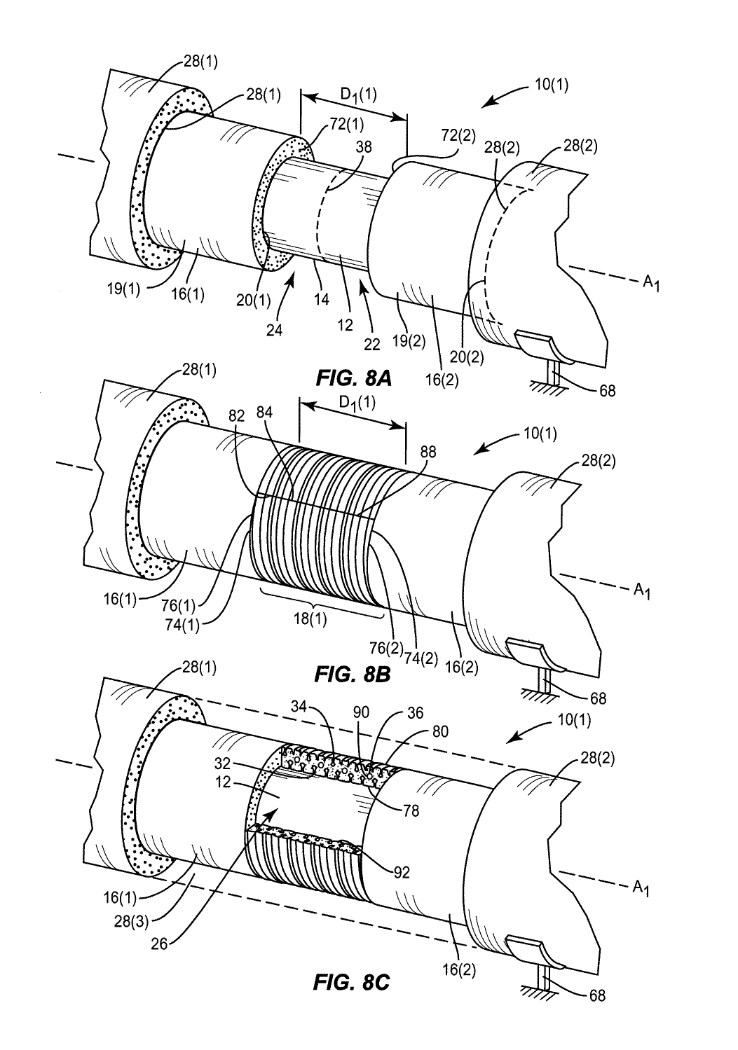

Now that the insulation system concept has been described using FIGS. 1A and 1B, various examples of an insulation system comprising a novel fastener for retaining one or more insulation wraps, which may be similar to insulation members 16, will be discussed relative to FIGS. 2A-7. Then, various examples of an insulation system comprising an expansion joint that can also employ the novel fastener will be discussed relative to FIGS. 8A-27C.

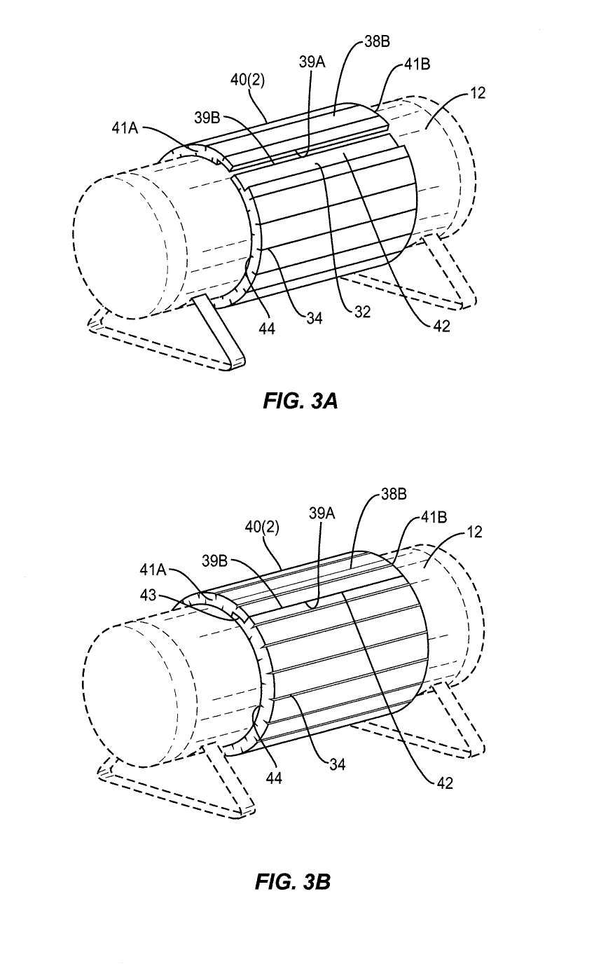

In this regard, FIGS. 2A and 2B depict a perspective view of a foam body 38, which may be similar to the insulation members 16 of FIGS. 1A and 1B, used as an insulation wrap 40(1) about the elongated container 12 at a datum ambient temperature. The insulation wrap 40(1) comprises a foam body 38, which may extend from a first longitudinal side 39A to a second longitudinal side 39B opposite the first longitudinal side 39A. The foam body 38 also extends from a first latitudinal side 41A to a second latitudinal side 41B opposite the first latitudinal side 41A. As shown in FIG. 2A, the insulation wrap 40(1) may also comprise at least one longitudinal fastener 42 configured to fasten the first longitudinal side 39A proximate to the second longitudinal side 39B to secure the thermoplastic profile in a shape or substantially the shape of the elongated container 12. The longitudinal fastener 42 may comprise a rabbet 43 (as shown in FIG. 3B) to better provide a more secure interface between the first longitudinal side 39A proximate to the second longitudinal side 39B.

FIG. 2B is a perspective view of the insulation wrap 40(1) of FIG. 2A at a reduced temperature less than the datum ambient temperature, wherein the longitudinal fastener 42 has failed. The reduced temperature may occur because the elongated container 12 became colder or the ambient temperature became colder than the datum ambient temperature. The insulation wrap 40(1) shrinks as its temperature decreases according to its thermal expansion coefficient, thereby causing increased stress at the longitudinal fastener 42. The increased stress may cause the longitudinal fastener 42 to fail to keep the first longitudinal side 39A and the second longitudinal side 39B proximate to each other. In this manner, the insulation wrap 40(1) may fall off the elongated container 12 and/or may provide less efficient insulating properties to the elongated container 12.

To improve the insulation wrap 40(1), FIGS. 3A and 3B depict perspective views of another example of an insulation wrap 40(2) disposed around the elongated container 12. As shown in FIG. 3A, the insulation wrap 40(2) may be placed under tension so that the longitudinal fastener 42 may keep the first longitudinal side 39A proximate to the second longitudinal side 39B. The insulation wrap 40(2) is similar to the insulation wrap 40(1), and so only differences will be discussed for clarity and conciseness. The insulation wrap 40(2) comprises the at least one outer channel 34 and the at least one inner channel 44 extending from the first latitudinal side 41A to the second latitudinal side 41B. In this manner, the outer channels 34 and the inner channels 44 are configured to change shape, as shown in FIG. 3B, to allow the foam body 38B to better expand to relieve the stress on the longitudinal fastener 42 and thereby keep the first longitudinal side 39A proximate to the second longitudinal side 39B during temperature fluctuations.

Furthermore, each of the inner channels 44 may be staggered around the circumference of the elongated container 12 as shown in FIGS. 3A and 3B, with respect to a respective nearest one of the at least one outer channel 34. In this way, the outer channels 34 and the inner channels 44 may be deeper within the foam body 38B, and the insulation wrap 40(2) may more easily expand along the circumferential direction of the elongated container 12 to relieve strain on the longitudinal fastener 42. Accordingly, the longitudinal fastener 42 is less likely to fail during temperature fluctuations, and the first longitudinal side 39A will be kept proximate to the second longitudinal side 39B during temperature fluctuations.

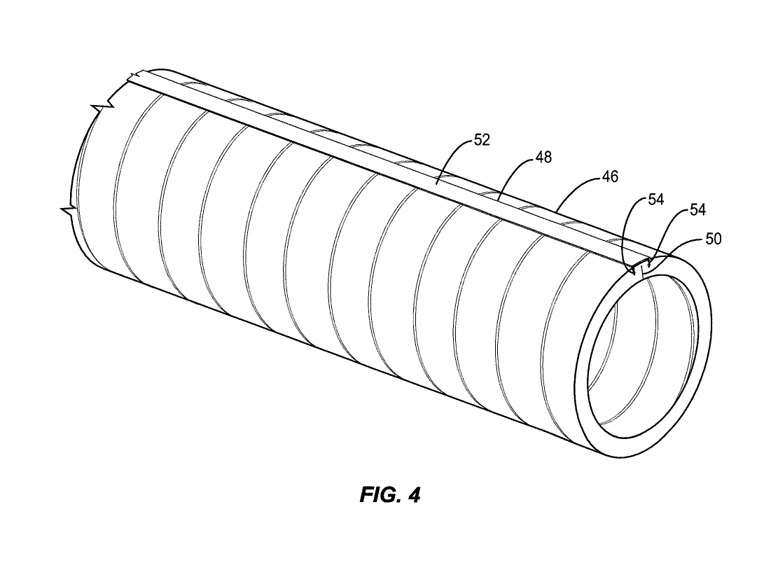

Many of the above described embodiments include a longitudinal seam to permit a pre-formed insulation wrap to be disposed around a cylindrical container in place. The insulation wrap may be retained in place by a number of methods, such as one or more fasteners, adhesives, or an external wraps. In this regard, FIG. 4 depicts a perspective view of an example of an insulation wrap 46 having an elongated fastener 48 along a seam 50 thereof, thereby retaining opposite longitudinal sides of the insulation wrap 46 together. In this embodiment, the insulation wrap 46 extends from a first longitudinal side around to a second longitudinal side opposite the first longitudinal side at the seam 50 to form a substantially cylindrical profile.

The fastener 48 extends in a longitudinal direction and is configured to fasten the first longitudinal side proximate to the second longitudinal side at the seam 50. The fastener 48 includes a substantially flat fastener body 52 configured to extend along and span the seam 50. The fastener 48 includes first and second rails 54 that extend from either side of the fastener body 52. The rails 54 are inserted into and engage the opposite longitudinal sides of the insulation wrap 46 proximate to the seam 50. In another embodiment, without limitation, the fastener body 52 may be curved or angled. The rails 54 may also extend from one or more different angles from the fastener body 52 without limitation.

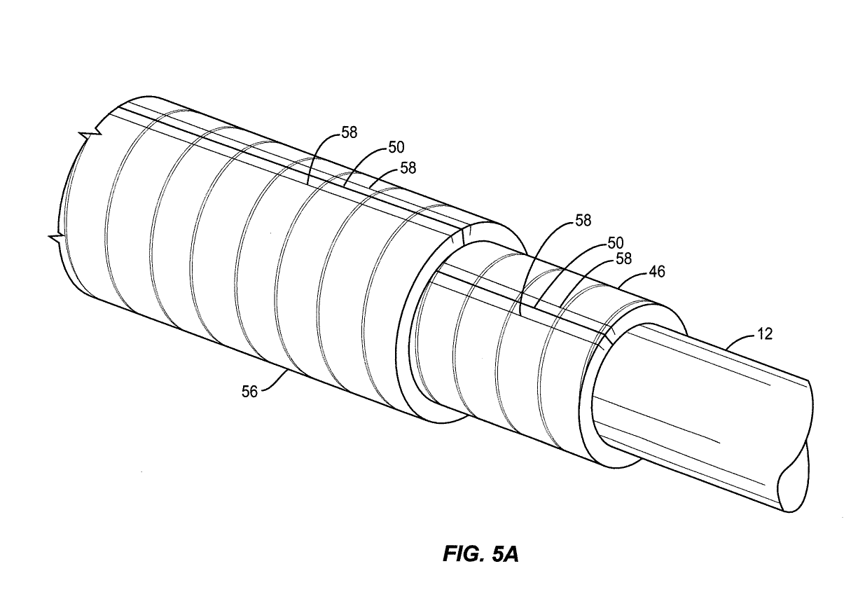

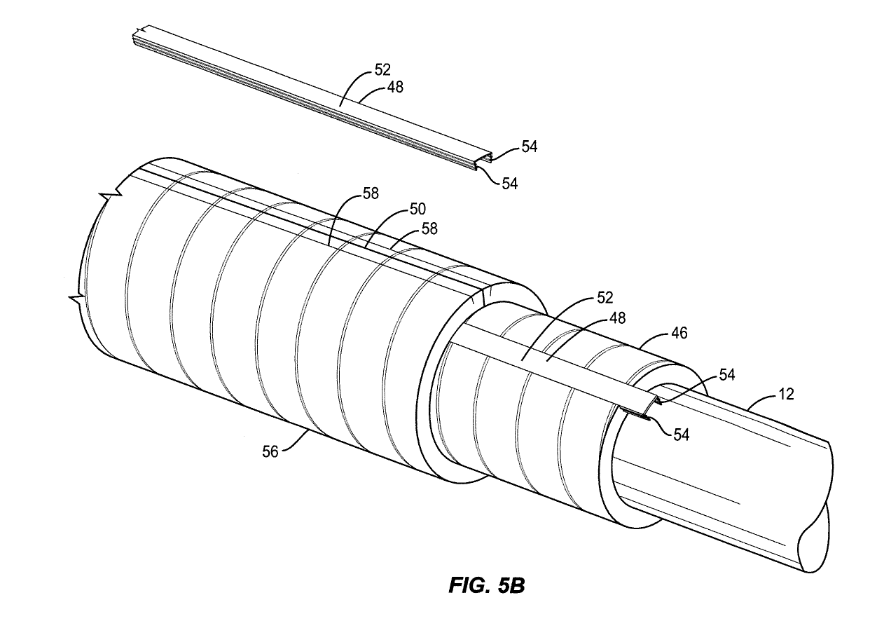

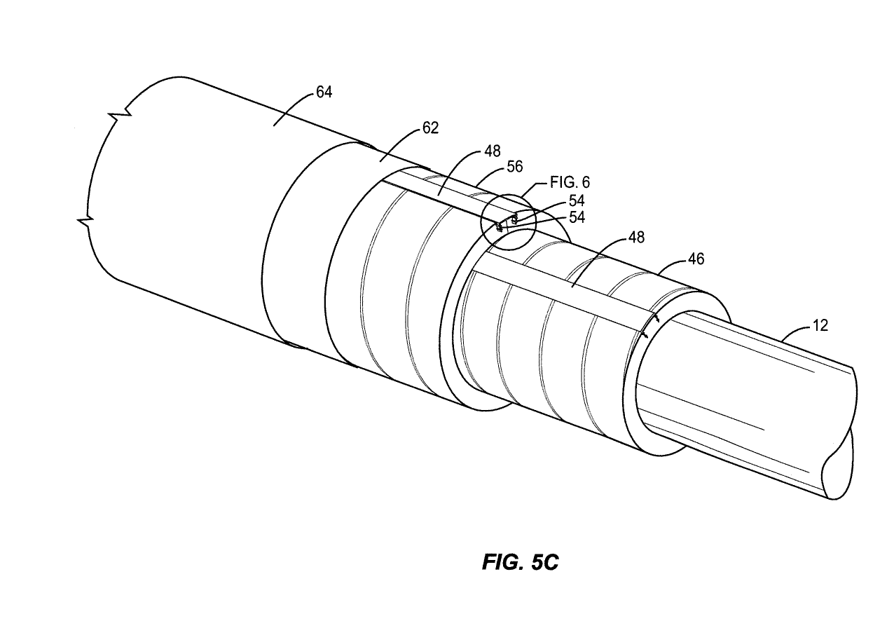

The fastener 48 thus allows the insulation wrap 46 to be retained in a shape or substantially the shape of a cross-sectional perimeter of an elongated container. Additional insulation wraps may also be disposed around insulation wrap 46 and may be retained by similar fasteners to fastener 48. In this regard, FIGS. 5A-5C depict perspective views of an example of a first insulation wrap 46 disposed around the elongated container 12, and a second insulation wrap 56 disposed around the first insulation wrap 46. As shown in FIG. 5A, the second insulation wrap 56 has first and second longitudinal sides that meet at seam 50. In addition, FIG. 5A illustrates that the first and second insulation wraps 46, 56 have a pair of longitudinal slots 58 on either side of slot 50. As shown in FIG. 5B, the slots 58 are configured to accommodate the rails 54 of fastener 48. After fastener 48 is applied to the first insulation wrap 46, the second insulation wrap 56 can be disposed around the first insulation wrap 46 and secured with another fastener 48. As shown in FIG. 5C, after the first and second insulation wraps 46, 56 are secured with fasteners 48, one or more sheathings, moisture barriers or other wraps 62, 64 can be disposed around the second insulation wrap 56 in a conventional manner.

To retain the rails 54 of the fastener 48 in the slots 58 of the insulation wraps 46, 56, the rails 54 can include a variety of different profiles to engage with the interior foam surfaces of slots 58. In this regard, FIG. 6 is a detailed perspective view of a portion of the example of FIG. 5C depicting structural details of the elongated fastener 48. In particular, FIG. 6 illustrates an exemplary profile of rails 54 extending into slots 58 of the second insulation wrap 56. In this example, each rail 54 includes one or more pairs of linear protrusions 66 extending from each side of the rail 54. When the rails 54 are press fit into the slots 58 of second insulation wrap 56, each protrusion 66 is pressed into the foam or other material of the second insulation wrap 56, thereby forming an enhanced friction fit for each rail 54 within the respective slot 58. In this manner, each fastener 48 can securely close each seam 50, while retaining the ability to manually remove the fastener 48, for example for maintenance or repair of the first or second insulation wrap 46, 56 or elongated container 12.

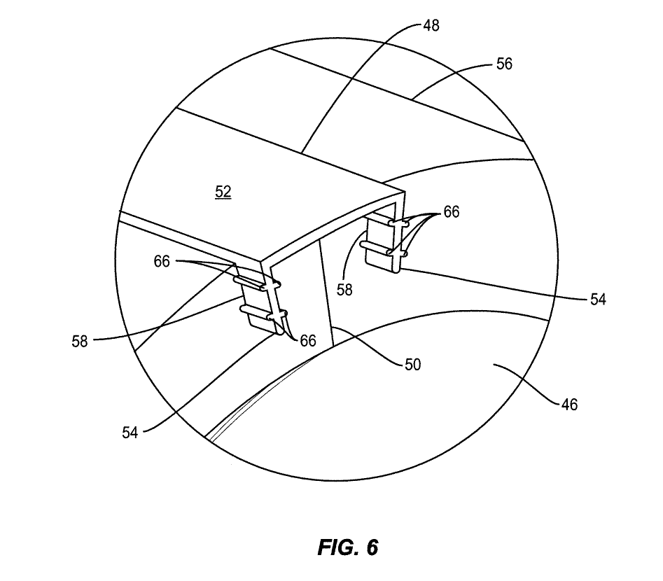

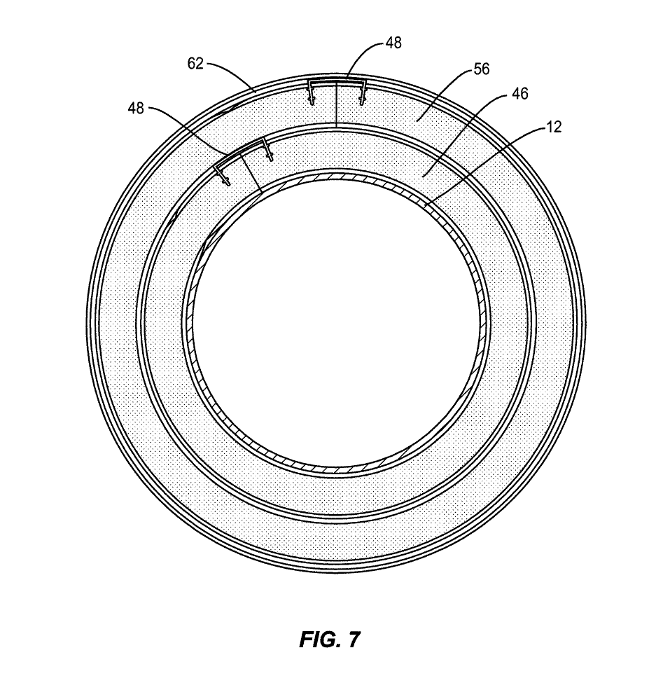

When using more than one insulation wrap, the seams 50 can be rotationally offset around the cylindrical container 12 to provide additional strength and redundancy to the insulation wraps 46, 56. In this regard, FIG. 7 is a cross-sectional view of the example of FIG. 5C illustrating the offset rotational arrangement of the first and second insulation wraps 46, 56 and associated fasteners 48. One advantage to this arrangement is that rotationally offsetting the seam 50 and fastener 48 of concentric insulation wraps 46, 56 helps to prevent failure of one fastener 48 from causing failure of the other fastener 48, in part because the unintended force distribution caused by the failure of the first fastener 48 is transferred to the other insulation wrap at a point away from the seam 50.

A variety of different materials may be used for the fastener 48. For example, a plastic, such as LDPE or MDPE polyethylene or other thermoplastic, may be used. In some embodiments, the fastener 48 may be made of metal. The fastener 48 may be cut to standardized lengths, custom lengths, or may be manufactured to specific lengths when forming the fasteners 48. In some embodiments, the fastener 48 may be formed having a length that is a multiple of a standardized length of a piece of insulation, thereby spanning multiple pieces of insulation. In some embodiments, the fastener 48 may be fastened across multiple adjacent insulation wraps 46.

In some embodiments, the dimensions of the fastener 48 may be selected based on the dimensions of the insulation wrap 46 to be fastened. For example, the width of the fastener body 52 may be 10% of the circumference of the insulation wrap 46 as installed, and the depth of the rails 54 may be 33% of the thickness of the insulation wrap 46. Thus, for an insulation wrap having a 1″ thickness and sized to enclose a container 12 having a 6.7″ external diameter (i.e., 8.7″ total diameter and 25.13″ circumference), the width of the fastener body 52 may be selected as 2.73″ and the depth of the rails 54 may be selected as 0.33″. Table 1 below illustrates a number of other width/depth combinations for different fasteners 48 and insulation wraps 46.

TABLE 1
(Dimensions in inches)

| | | Thickness >> | | | | | | | |
|---|---|---|---|---|---|---|---|---|---|
| | Diam- | 1 | | 1½ | | 2 | | 2½ | |
| ID | eter | Width | Depth | Width | Depth | Width | Depth | Width | Depth |
| ½ | 0.860 | 0.90 | 0.33 | 1.21 | 0.50 | 1.53 | 0.66 | 1.84 | 0.83 |
| ¾ | 1.070 | 0.96 | 0.33 | 1.28 | 0.50 | 1.59 | 0.66 | 1.91 | 0.83 |
| 1 | 1.330 | 1.05 | 0.33 | 1.36 | 0.50 | 1.67 | 0.66 | 1.99 | 0.83 |
| 1¼ | 1.680 | 1.16 | 0.33 | 1.47 | 0.50 | 1.78 | 0.66 | 2.10 | 0.83 |
| 1½ | 1.920 | 1.23 | 0.33 | 1.55 | 0.50 | 1.86 | 0.66 | 2.17 | 0.83 |
| 2 | 2.410 | 1.39 | 0.33 | 1.70 | 0.50 | 2.01 | 0.66 | 2.33 | 0.83 |
| 2½ | 2.910 | 1.54 | 0.33 | 1.86 | 0.50 | 2.17 | 0.66 | 2.48 | 0.83 |
| 3 | 3.530 | 1.74 | 0.33 | 2.05 | 0.50 | 2.37 | 0.66 | 2.68 | 0.83 |
| 3½ | 4.030 | 1.89 | 0.33 | 2.21 | 0.50 | 2.52 | 0.66 | 2.84 | 0.83 |
| 4 | 4.530 | 2.05 | 0.33 | 2.37 | 0.50 | 2.68 | 0.66 | 2.99 | 0.83 |
| 4½ | 5.030 | 2.21 | 0.33 | 2.52 | 0.50 | 2.84 | 0.66 | 3.15 | 0.83 |
| 5 | 5.640 | 2.40 | 0.33 | 2.71 | 0.50 | 3.03 | 0.66 | 3.34 | 0.83 |
| 6 | 6.700 | 2.73 | 0.33 | 3.05 | 0.50 | 3.36 | 0.66 | 3.68 | 0.83 |
| 7 | 7.700 | 3.05 | 0.33 | 3.36 | 0.50 | 3.68 | 0.66 | 3.99 | 0.83 |
| 8 | 8.700 | 3.36 | 0.33 | 3.68 | 0.50 | 3.99 | 0.66 | 4.30 | 0.83 |
| 9 | 9.700 | 3.68 | 0.33 | 3.99 | 0.50 | 4.30 | 0.66 | 4.62 | 0.83 |
| 10 | 10.830 | 4.03 | 0.33 | 4.34 | 0.50 | 4.66 | 0.66 | 4.97 | 0.83 |
| 11 | 11.830 | 4.34 | 0.33 | 4.66 | 0.50 | 4.97 | 0.66 | 5.29 | 0.83 |
| 12 | 12.840 | 4.66 | 0.33 | 4.98 | 0.50 | 5.29 | 0.66 | 5.60 | 0.83 |
| 13 | 13.840 | 4.98 | 0.33 | 5.29 | 0.50 | 5.60 | 0.66 | 5.92 | 0.83 |
| 14 | 14.090 | 5.05 | 0.33 | 5.37 | 0.50 | 5.68 | 0.66 | 6.00 | 0.83 |
| 15 | 15.090 | 5.37 | 0.33 | 5.68 | 0.50 | 6.00 | 0.66 | 6.31 | 0.83 |
| 16 | 16.090 | 5.68 | 0.33 | 6.00 | 0.50 | 6.31 | 0.66 | 6.63 | 0.83 |
| 17 | 17.090 | 6.00 | 0.33 | 6.31 | 0.50 | 6.63 | 0.66 | 6.94 | 0.83 |
| 18 | 18.090 | 6.31 | 0.33 | 6.63 | 0.50 | 6.94 | 0.66 | 7.25 | 0.83 |
| 19 | 19.090 | 6.63 | 0.33 | 6.94 | 0.50 | 7.25 | 0.66 | 7.57 | 0.83 |
| 20 | 20.090 | 6.94 | 0.33 | 7.25 | 0.50 | 7.57 | 0.66 | 7.88 | 0.83 |
| 21 | 21.090 | 7.25 | 0.33 | 7.57 | 0.50 | 7.88 | 0.66 | 8.20 | 0.83 |
| 22 | 22.090 | 7.57 | 0.33 | 7.88 | 0.50 | 8.20 | 0.66 | 8.51 | 0.83 |
| 23 | 23.090 | 7.88 | 0.33 | 8.20 | 0.50 | 8.51 | 0.66 | 8.82 | 0.83 |
| 24 | 24.090 | 8.20 | 0.33 | 8.51 | 0.50 | 8.82 | 0.66 | 9.14 | 0.83 |

In the above Table 1, “ID” refers to the internal diameter of the container 12 (e.g., a pipe capacity), “Diameter” refers to the external diameter of the container 12 including wall thickness, “Thickness” refers to the wall thickness of the insulation wrap 46, “Width” refers to the width of fastener body 52 of fastener 48, and “Depth” refers to the depth of each rail 54 of fastener 48.

Embodiments of the novel fasteners described above may also be used with an insulation system comprising an expansion joint. In this regard, FIGS. 8A-8C are perspective side views of a first embodiment of an insulation system 10(1) disposed around an elongated container 12. The elongated container 12 may be, for example, a pipe for liquid, gas, or vapor flow. FIG. 8A does not include all components of the insulation system 10(1) in order to show the pipe 12. The pipe 12 (or other “elongated container”) may be a natural gas pipeline carrying a temperature-sensitive liquid such as liquefied natural gas (LNG) through an inside passageway at less than negative one-hundred sixty-two (−162) degrees Celsius, or a refrigerant pipe carrying refrigerant to a food-processing freezer at sub-zero (0) degrees Fahrenheit, as non-limiting examples. The pipe 12 may be made of a strong pressure-resistant material, for example, metal, composite, or hardened plastic. An external surface 14 of the pipe 12 may be concentric about a center axis A₁. The ends of the pipe are depicted as being broken to show indeterminate length parallel to the center axis A₁ in FIGS. 8A-8C.

The pipe 12 may be installed in an ambient environment which may include, for example, ambient temperatures from negative fifty (−50) to forty (+40) degrees Celsius. The ambient environment may include humidity. An operating temperature T_{O} as used herein is a temperature of the external surface 14 of pipe 12 when contents flow through the pipe 12. The operating temperature T_{O} as used herein is always different than the ambient temperature. When contents do not flow through the pipe 12, then the temperature of the exterior of the pipe 12 may reach ambient temperature at equilibrium.

If the pipe 12 is not insulated, the external surface 14 of the pipe 12 may be exposed to the ambient environment, and damage and/or expense may occur. The damage and/or expense may include, for example, higher energy expense, accumulation of ice, corrosion, breakage and/or leakage of the pipe 12.

The insulation system 10(1) may include at least two insulation members 16(1), 16(2), an expansion joint 18(1) (FIG. 1B), and second layer insulation members 28(1), 28(2). The insulation members 16(1), 16(2) may be made, for example, of a polymeric material with a density or stiffness high enough to prevent deformation when supported directly or indirectly by a pipe support 68. The insulation members 16(1), 16(2) may each include an external surface 19(1), 19(2) and an internal surface 20(1), 20(2), respectively. The internal surface 20(1), 20(2) of the insulation members 16(1), 16(2) may abut against the external surface 14 of the pipe 12 and thereby may minimize convection heat transfer between the pipe 12 and atmosphere.

The second layer insulation members 28(1), 28(2) may include inward-facing surfaces 30(1), 30(2) abutting against the external surfaces 19(1), 19(2) of the insulation members 16(1), 16(2), respectively, to prevent convection heat transfer and radiant heat transfer with the ambient environment. The second layer insulation members 28(1), 28(2) may be made, for example, of a polymeric material with a density high enough to prevent deformation when supported directly or indirectly by the pipe support 68.

The insulation members 16(1), 16(2) may include abutment surfaces 72(1), 72(2), which may become separated by a gap 22 of a distance D₁(1) when the insulation members 16(1), 16(2) and the external surface 14 of the pipe 12 may be at the ambient temperature. The distance D₁(1) is meant to describe the gap 22 into which an installer would insert/install the expansion joint 18(1), and may also describe the size of the gap that may occur due to thermal contraction. As shown in FIG. 8B, the gap 22 may be filled by the expansion joint 18(1) configured to insulate a portion 24 of the pipe 12 in the gap 22.

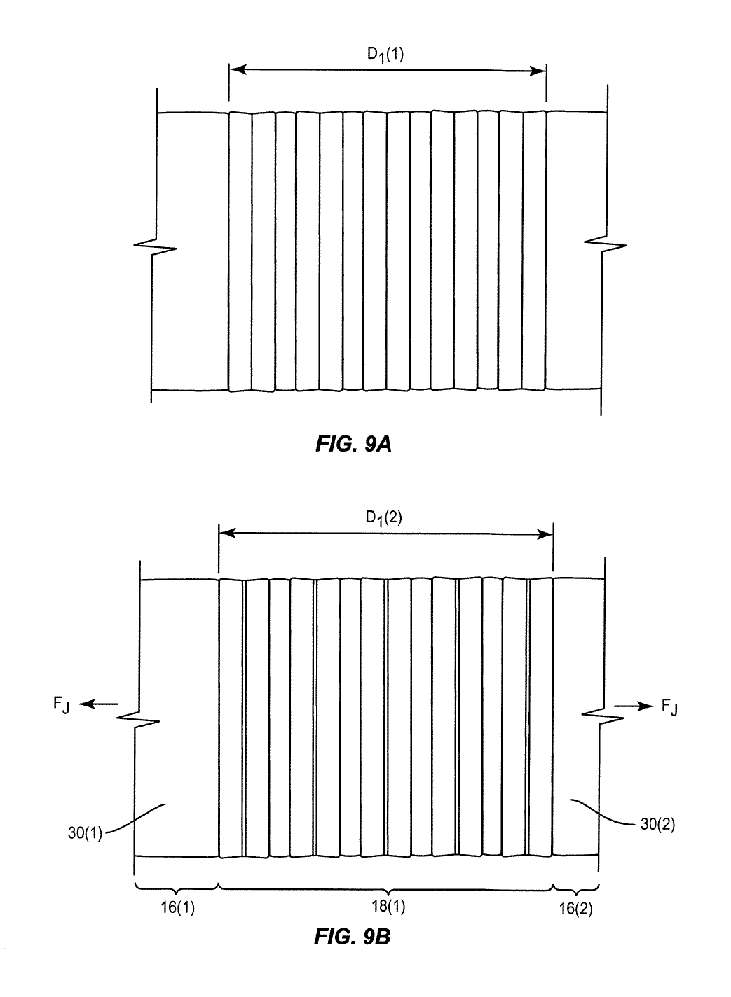

The insulation members 16(1), 16(2) may include a thermal expansion coefficient which may enable the insulation members 16(1), 16(2) to contract parallel to the center axis A₁ when the external surface 14 of the pipe 12 reaches the operating temperature T_{O}. FIGS. 9A and 9B are side views depicting the insulation members 16(1), 16(2) and the expansion joint 18(1) of FIG. 8B when the external surface 14 of the pipe 12 reaches the ambient temperature and the operating temperature T_{O}, respectively. When the insulation members 16(1), 16(2) contract, then the gap 22 may widen to a distance of D₁(2) when the external surface 14 of the pipe 12 reaches the operating temperature T_{O}. The distance D₁(2) may be longer than the distance D₁(1) parallel to the center axis A₁. This longer distance D₁(2) requires the expansion joint 18(1) to expand to completely fill the gap 22. When the external surface 14 of the pipe 12 again reaches ambient temperature as the flow may cycle between on and off, the gap 22 may return to the distance D₁(1) and the expansion joint 18(1) may contract to fill this gap 22.

With reference back to FIG. 8B, the insulation system 10(1) may include attachment members 74(1), 74(2) to attach the expansion joint 18(1) to the insulation members 16(1), 16(2), respectively. The attachment members 74(1), 74(2) may comprise, for example, duct tape, adhesive material(s), thermal weld(s), and/or cohesive material(s). The attachment members 74(1), 74(2) may allow the gap 22 to be fully filled by the expansion joint 18(1) as the temperature of the exterior of the pipe 12 changes and as the ambient temperature changes. The attachment members 74(1), 74(2) may also be configured to seal the gap 22 to prevent humidity from the ambient environment from reaching the pipe 12, where damaging ice could develop. The attachment members 74(1), 74(2) seal the gap 22 by preventing humidity and airflow from moving between end surfaces 76(1), 76(2) (or “first and second latitudinal sides”) of the expansion joint 18(1) and the abutment surfaces 72(1), 72(2) of the insulation members 16(1), 16(2), respectively. The attachment members 74(1), 74(2) may allow the gap 22 to be fully filled by the expansion joint 18(1) imparting a joint force F_{J} (FIG. 9B) upon the expansion joint 18(1). The joint force F_{J} may be parallel to the center axis A₁, and may be a compressive or tensile force upon the expansion joint 18(1).

With reference back to FIG. 8C, the expansion joint 18(1) may include an internal surface 78 and an external surface 80 opposite the internal surface 78. The internal surface 78 of the expansion joint 18(1) may be configured to abut against the portion 26 of the external surface 14 of the pipe 12 to better insulate the pipe 12 by minimizing convection heat transfer from the external surface 14 of the pipe 12.

The expansion joint 18(1) may extend from a first surface 82 (or “first longitudinal side”) to a second surface 84 (or “second longitudinal side”) along a perimeter of the external surface 14 of the pipe 12. The perimeter may be in a geometric plane perpendicular to the center axis A₁ and the perimeter may be concentric to the center axis A₁. The first surface 82 and the second surface 84 may be attached using a second attachment member 88. The second attachment member 88 may comprise, for example, duct tape, adhesive material(s), thermal weld(s), and/or cohesive material(s). The second attachment member 88 may allow the expansion joint 18(1) to remain in abutment with the pipe 12 and prevent humidity from the ambient environment from reaching the pipe 12. Further, the second attachment member 88 may be installed parallel to axis A₁ (FIG. 8B) or parallel to outer channels 34 (FIG. 8C) so as to not inhibit the expansion or contraction of the outer channels 34, the inner channels 44 (FIGS. 3A and 3B), or inner passageway 36 (FIG. 8C).

As shown in FIG. 8C, the external surface 80 of the expansion joint 18(1) may include outer channels 34 and the internal surface 78 may include inner channels 44. The outer channels 34 and the inner channels 44 may be formed with an extrusion process. The inner channels 44 and the outer channels 34 may be grooves including a curvilinear shape. The inner channels 44 and the outer channels 34 may extend from the first surface 82 to the second surface 84 (FIG. 8C). The inner channels 44 and the outer channels 34 may reduce the stiffness of the expansion joint 18(1) in a direction parallel to the center axis A₁, and may each be disposed orthogonal to the center axis A₁ to enable the expansion joint 18(1) to expand in a direction parallel to the center axis A₁ to keep the gap 22 filled and the portion 26 of the pipe 12 insulated.

With continuing reference to FIG. 8C, the expansion joint 18(1) may further include at least one inner passageway 36 disposed between the internal surface 78 and the external surface 80 of the expansion joint 18(1). The inner passageway 36 may be formed through an extrusion process. Each of the at least one inner passageway 36 may extend from a first opening 90 in the first surface 82 to a second opening 92 in the second surface 84 (FIG. 8B). The inner passageway 36 may reduce the stiffness of the expansion joint 18(1) in a direction parallel to the center axis A₁, and may be disposed orthogonal to the center axis A₁ to enable the expansion joint 18(1) to expand in a direction parallel to the center axis A₁ to keep the gap 22 filled and the portion 26 of the pipe 12 insulated.

FIG. 8C further depicts a second layer insulation member 28(3) that may be disposed between the second layer insulation members 28(1), 28(2) to further insulate the pipe 12 from the atmosphere. The second layer insulation member 28(3) may abut against the external surface 80 of the expansion joint 18(1). It is noted that the gap 22 may still expand and contract between the distance D₁(1) and D₁(2) as the temperature of the external surface 14 of the pipe 12 changes (FIGS. 9A and 9B).

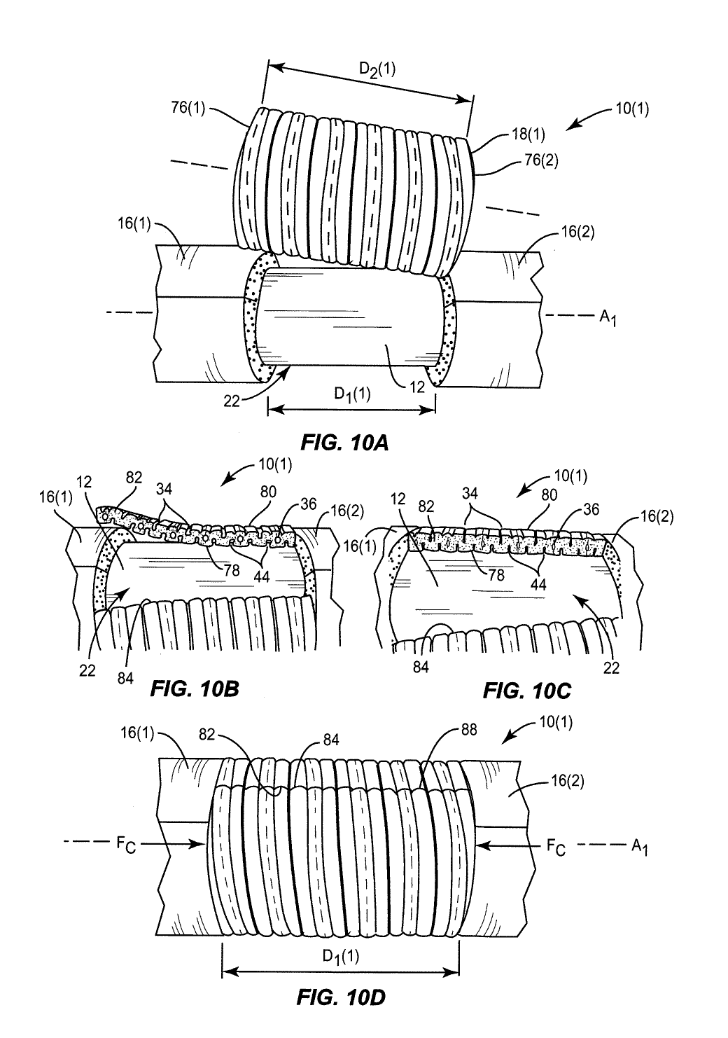

FIGS. 10A-10C depict the expansion joint 18(1) being installed to be part of the insulation system 10(1) of FIGS. 8A-8C. The expansion joint 18(1) may include a distance D₂(1) between the end surfaces 76(1), 76(2) when not installed in the gap 22 and at the ambient temperature. The distance D₂(1) may be greater than the distance D₁(1) of the gap 22 at the ambient temperature. The expansion joint 18(1) may be compressed in order to be installed into the gap 22. For example, if the gap 22 has the distance D₁(1) of ten (10) inches and the expansion joint 18(1) has the distance D₂(1) of twelve (12) inches, then the expansion joint 18(1) may be compressed to within ten (10) inches to fit within the gap 22. Compressing the expansion joint 18(1) having a distance D₂(1) greater than the distance D₁(1) allows the expansion joint 18(1) to be disposed in the gap 22 with a compression force F_{C} (FIG. 10D). Attachment members 74(1), 74(2) may be under compression by compressive force F_{C} or attachment members 74(1), 74(2) may be installed after expansion joint 18(1) is disposed in the gap 22 with compressive force F_{C}, to provide a better seal against humidity from the ambient environment reaching the pipe 12. Further, the compression force F_{C} allows the expansion joint 18(1) to better expand to fill the gap 22 when the gap 22 expands to a distance D₁(2) as the external surface 14 of the pipe 12 reaches the operating temperature T_{O}.

The expansion joint 18(1) may be installed into the gap 22 with the first surface 82 installed before the second surface 84, or vice versa. FIG. 4C depicts the first surface 82 being installed initially in the gap 22. The outer channels 34, inner channels 44, and the at least one inner passageway 36 may at least partially close as the expansion joint 18(1) is installed in the gap 22, as depicted in the differences between FIGS. 10B and 10C. The expansion joint 18(1) may contract to within the distance D₁(1) as the outer channels 34 and inner channels 44, and the at least one inner passageway 36 may at least partially close. In addition, a material of the expansion joint 18(1) may contract to help the expansion joint 18(1) more easily fit within the gap 22.

As is depicted in FIG. 10D, when both the first surface 82 and the second surface 84 are installed into the gap 22, then the second attachment member 88 may attach the first surface 82 and second surface 84, and the attachment member 74(1), 74(2) may attach the expansion joint 18(1) to the insulation members 16(1), 16(2). The attachment members 74(1), 74(2) and second attachment member 88 may be applied to the insulation system 10(1) with, for example, a heat gun and/or adhesive applicator.

In another embodiment, different materials may be used to provide the insulation members and the expansion joints. The insulation members may be provided of a first material(s) to provide the desired thermal insulation characteristics and/or stiffness support characteristics. To facilitate the enhanced ability for the insulation products to counteract thermal expansion and/or contraction, a different material may be provided in expansion joints attached to insulation members. The material(s) selected for the expansion joints may have a different coefficient of thermal expansion from the insulation members, and thus provide more flexibility to counteract thermal expansion and/or contraction. In this manner, a composite insulation product is formed with insulation members of a first material(s) type, and expansion joints of a second, different material(s) type. As a non-limiting example, engineered thermoplastic insulation members having desired profiles may be employed to provide excellent insulation properties, moisture resistance, and support characteristics, but may not be able to counteract thermal expansion and contraction well. In another example, the expansion joints may be provided of a thermoset material, such as a polyurethane, to provide enhanced flexibility to allow the insulation members to counteract thermal expansion and contraction.

Non-limiting examples of thermoplastic materials that can be used include polypropylene, polypropylene copolymers, polystyrene, polyethylenes, ethylene vinyl acetates (EVAs), polyolefins, including metallocene catalyzed low density polyethylene, thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and the like, and derivatives thereof.

Non-limiting examples of thermoset materials include polyurethanes, natural and synthetic rubbers, such as latex, silicones, EPDM, isoprene, chloroprene, neoprene, melamine-formaldehyde, and polyester, and derivatives thereof. The density of the thermoset material may be provided to any density desired to provide the desired resiliency and expansion characteristics. The thermoset material can be soft or firm, depending on formulations and density selections. Further, if the thermoset material selected is a natural material, such as latex for example, it may be considered biodegradable.

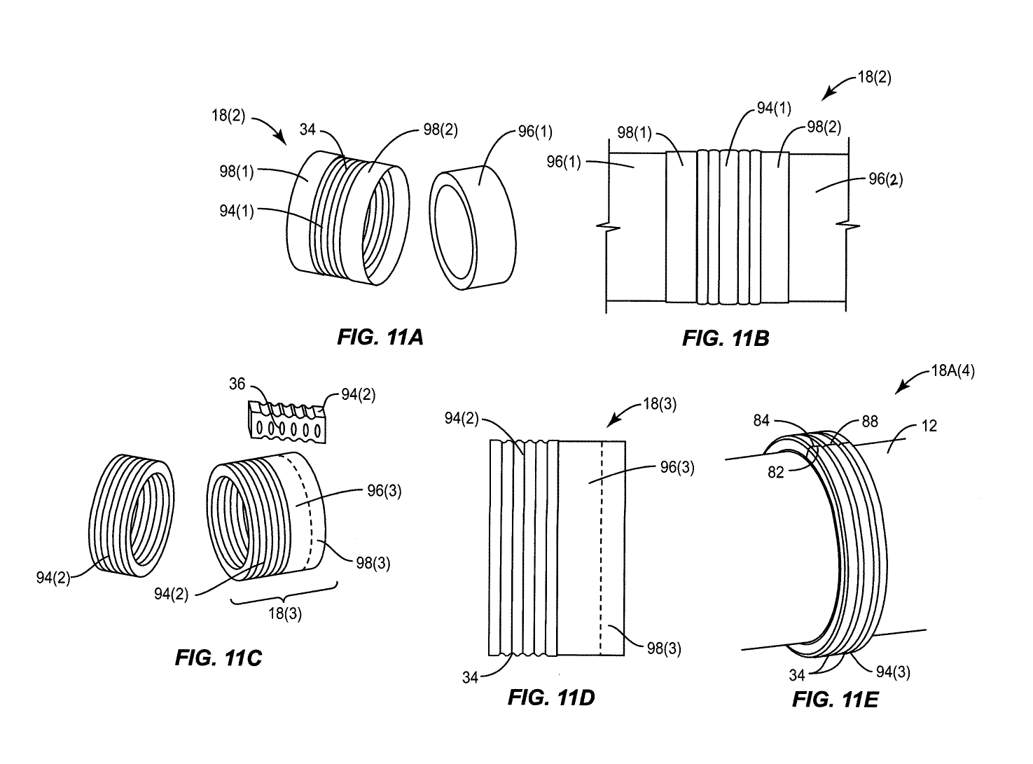

In this regard, FIGS. 11A-11E depict alternative examples of the expansion joint 18(1). FIGS. 11A-11B depict an expansion joint 18(2). The expansion joint 18(2) may operate similar to the expansion joint 18(1) of FIG. 8B, as discussed previously. However, the expansion joint 18(2) may comprise a first section 94(1) and at least one end section 96(1), 96(2) attached by third attachment members 98(1), 98(2). The third attachment members 98(1), 98(2) may comprise, for example, duct tape, adhesive material(s), thermal weld(s), and/or cohesive material(s). FIG. 11A shows the end section 96(1) may be detached from the first section 94(1) and the third attachment member 98(1). FIG. 11B depicts the expansion joint 18(2) with the at least one end sections 96(1), 96(2) attached by the third attachment members 98(1), 98(2). The end sections 96(1), 96(2) may be made of a different material having more resilience than the first section 94(1). More resiliency may allow the expansion joint 18(2) to expand or contract more quickly to respond to dimensional changes of the gap 22. The different material of the end sections 96(1), 96(2) may comprise, for example, a polyolefin or thermoset materials.

The first section 94(1) may also include outer channels 34. The outer channels 34 may reduce the stiffness of the first section 94(1) to allow the expansion joint 18(2) to more easily fit within the gap 22.

FIGS. 11C and 11D depict a perspective and a side view of an expansion joint 18(3) which is another example of the expansion joint 18(1). The expansion joint 18(3) may operate similar to the expansion joint 18(1) of FIG. 8B, as discussed previously. However, the expansion joint 18(3) may comprise a first section 94(2) attached to an end section 96(3) with an alternative attachment member 98(3). The alternative attachment member 98(3) may comprise, for example, duct tape, adhesive material(s), thermal weld(s), and/or cohesive material(s). The end section 96(3) may be made of a different material that may be more resilient than the first section 94(2). The added resiliency may allow the expansion joint 18(3) to expand or contract more quickly to respond to dimensional changes of the gap 22. The different material of the end sections 96(1), 96(2) may comprise, for example, polyolefin or thermoset materials.

The first section 94(2) may also include outer channels 34, inner channels 44, and at least one inner passageway 36, which may reduce the stiffness of the first section 94(2). The reduction of stiffness may allow the expansion joint 18(3) to more easily fit within the gap 22.

It is noted that in FIG. 11C, a small portion of the first section 94(2) is provided atop the expansion joint 18(3) to illustrate the inner passageways 36. It is also noted that in FIG. 11C, a first section 94(2) is provided to the left of the expansion joint 18(3) to better illustrate the outer channels 34 and the inner channels 44.

FIG. 11E depicts a perspective view of an expansion joint 18A(4) which may be another example of the expansion joint 18(1). In FIG. 11E, the expansion joint 18A(4) is insulating a pipe 12. The expansion joint 18A(4) may operate similar to the expansion joint 18(1) of FIG. 8B, as discussed previously. The expansion joint 18A(4) may comprise a first section 94(3) with outer channels 34 to reduce stiffness of the expansion joint 18A(4). The expansion joint 18A(4) may extend from a first surface 82 to a second surface 84 opposite the first surface 82. The first surface 82 and the second surface 84 may be connected at a second attachment member 88 to prevent the expansion joint 18A(4) from detaching from the pipe 12.

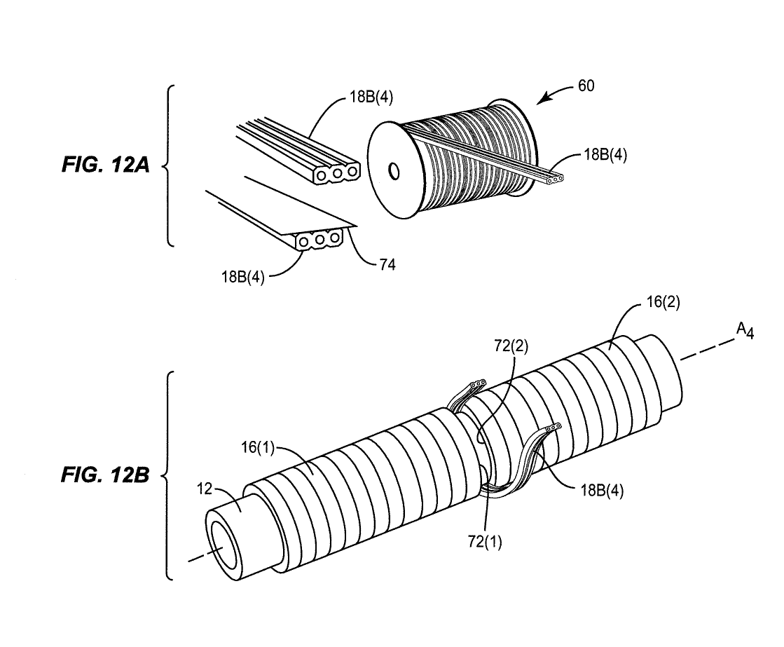

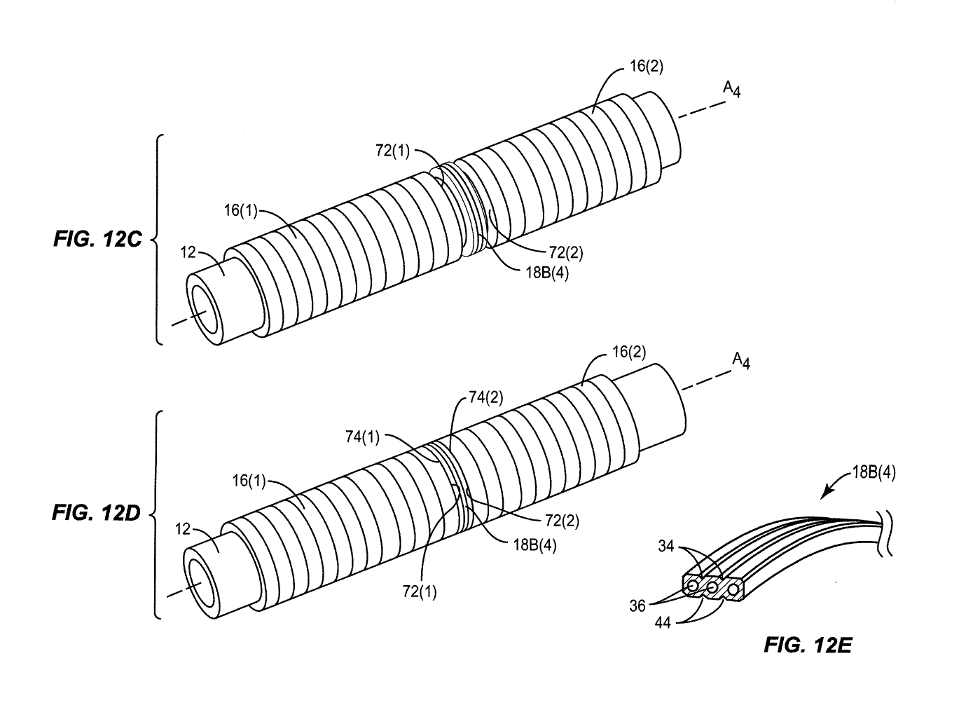

In another embodiment shown in FIG. 12A, an expansion joint 18B(4) may be similar to the expansion joint 18A(4) and so only the differences will be discussed for clarity and conciseness. The expansion joint 18B(4) may be extruded and then wound around a spool 60 for annealing to thermally form a radius of curvature as part of the expansion joint 18B(4) to make installation onto the pipe 12 easier. The expansion joints 18B(4) may also be paid out from the spool 60 in the field (as opposed to the factory), and cut to sufficient length in the field to fully wrap the elongated container (e.g., pipe) circumference and thus make installation of the expansion joint more convenient.

In this regard, FIGS. 12A-12D depict perspective views of process steps to install the expansion joint 18B(4) upon a pipe 12 including a center axis A₄. FIG. 12A depicts the expansion joint 18B(4) may be paid out from a spool 60. The spool 60 may allow the expansion joint 18B(4) to be conveniently stored and transported. The expansion joint 18B(4) may be spooled without (as depicted in the top left of FIG. 12A) or with an attachment member 74 (as shown at the bottom left of FIG. 12A).

FIGS. 12B and 12C depict that the expansion joint 18B(4) may be compressed parallel to the center axis A₄ and disposed around the pipe 12 and between the insulation members 16(1), 16(2).

FIG. 12D depicts the expansion joint 18B(4) installed on pipe 12 and with insulation members 16(1), 16(2) moved to abut against expansion joint 18B(4) so that the abutment surfaces 72(1), 72(2) of the insulation members 16(1), 16(2) are respectively in contact with the expansion joint 18B(4). The expansion joint 18B(4) may then be joined with the attachment members 74(1), 74(2) to the insulation members 16(1), 16(2). In this manner, the outer channels 34 of the expansion joint 18B(4), the inner channels 44 of the expansion joint 18B(4), and the inner passageways 36 of the expansion joint 18B(4), as depicted in a cross-section perspective view of FIG. 12E, can be configured to change shape to allow expansion and contraction of the expansion joint 18B(4) to maintain contact with the insulation members 16(1), 16(2).

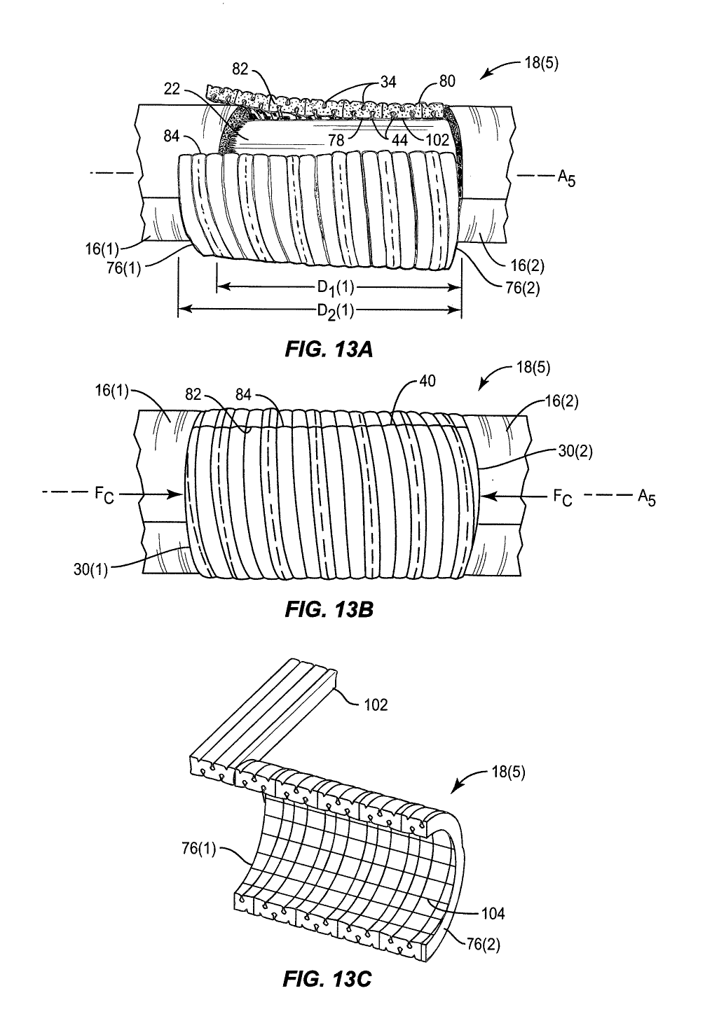

FIGS. 13A-13C depict a side view during installation, a side view after installation, and a partial perspective view of an expansion joint 18(5), which may be another example of the expansion joint 18(1). The expansion joint 18(5) may operate similar to the expansion joint 18(1) of FIG. 8B, as discussed previously. The expansion joint 18(5) may comprise a foam profile 102, for example, thermoplastic, including an internal surface 78 having inner channels 44 and an external surface 80 having outer channels 34. The foam profile 102 may be wrapped helically and thermally bonded together in the helical shape. The helical shape may be cut parallel to the center axis A₅ to create the first surface 82 and the second surface 84. The end surfaces 76(1), 76(2) may be created orthogonal to the center axis A₅ by slicing the expansion joint 18(5).

FIG. 13A depicts that the expansion joint 18(5) may include a distance D₂(1) between the end surfaces 76(1), 76(2) when not installed in the distance D₁(1) of gap 22 and when at the ambient temperature. The distance D₂(1) may be greater than the distance D₁(1) of the gap 22 at the ambient temperature. The expansion joint 18(5) may be compressed in order to be installed into the gap 22. For example, if the gap 22 has the distance D₁(1) of ten (10) inches and the expansion joint 18(5) has a the distance D₂(1) of twelve (12) inches, then the expansion joint 18(5) may be compressed to within ten (10) inches to fit within the gap 22. Compressing the expansion joint 18(5) having a distance D₂(1) greater than the distance D₁(1) allows the expansion joint 18(1) to be disposed in the gap 22 with a compression force F_{C} (FIG. 13B). The compression force F_{C} places the attachment members 74(1), 74(2) also under compression to provide a better seal against humidity from the ambient environment reaching the pipe 12. Further, the compression force F_{C} allows the expansion joint 18(5) to better expand to fill the gap 22 when the gap 22 expands to a distance D₁(2) (FIG. 13B) as the external surface 14 of the pipe 12 reaches the operating temperature T_{O} so that the pipe 12 is fully insulated.

In this regard, FIG. 13A depicts the first surface 82 being installed initially in the gap 22. The outer channels 34 and inner channels 44 may be at least partially closed as the expansion joint 18(5) is installed in the gap 22. The expansion joint 18(5) may contract or be pre-compressed to within the distance D₁(1) of the outer channels 34, and inner channels 44 may at least partially close. In addition, a material of the expansion joint 18(5) may also contract or be pre-compressed to help the expansion joint 18(5) more easily fit within the gap 22.

FIG. 13B shows that both the first surface 82 and the second surface 84 are installed into the gap 22, then the second attachment member 88 may attach the first surface 82 and second surface 84, and the attachment members 74(1), 74(2) may attach the expansion joint 18(5) to the insulation members 16(1), 16(2). The attachment members 74(1), 74(2) and second attachment member 88 may be provided to the insulation system 10(1) with, for example, a heat gun and/or adhesive applicator.

FIG. 13C shows a partial perspective view of the expansion joint 18(5) comprising the foam profile 102 in a helical shape. The left side of FIG. 13C shows a straight elongated section of the foam profile 102 before entering the helical shape.

FIG. 13C also depicts that the expansion joint 18(5) may optionally include at least one second channels 104 which extend between end surfaces 76(1), 76(2). The second channels 104 may be applied to the expansion joint 18(5) with a hot wire cutter to partially cut material of the expansion joint 18(5). In this manner, the expansion joint 18(5) may be more easily stretched during installation to surround a circumference of the pipe 12.

In another embodiment for comparison, and discussed in more detail later in relation to FIGS. 23A and 23B, the expansion joint 18(5) may be formed and factory compressed and/or annealed at an elevated temperature so that a pre-compression of the expansion joint 18(5) is provided, so that further compression during installation may be reduced or eliminated to make installation more convenient. In this example, when the exterior surface 14 of the pipe 12 reaches an operating temperature colder than ambient temperature, the insulation members 16(1), 16(2) may contract and therefore pull the expansion joint 18(5) to an expanded length to cover the increased gap between insulation members 16(1), 16(2). When the pipe 12 may be turned off or cycled as is common in refrigeration systems, for example, the insulation members 16(1), 16(2) may return to ambient temperature by expanding, and the expansion joint 18(5) may contract to an original pre-compressed state.

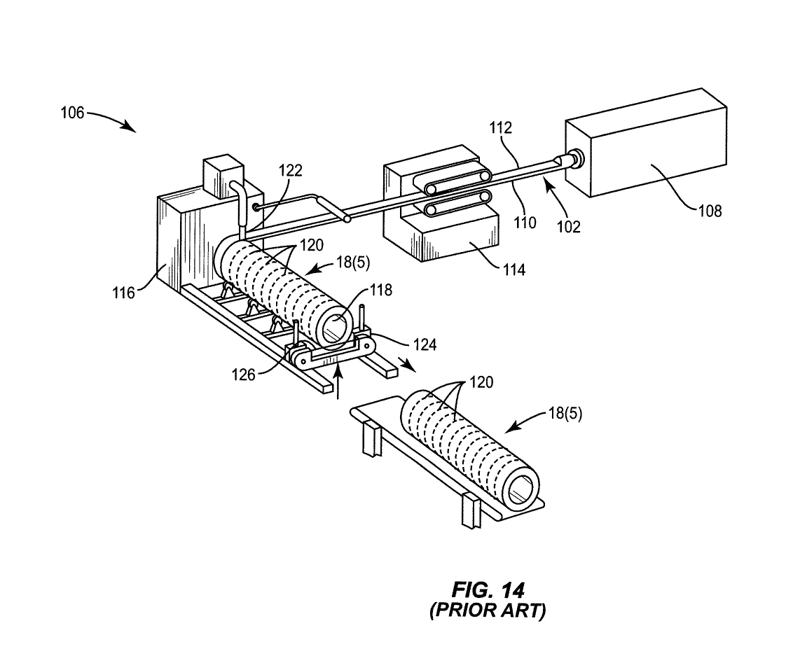

FIG. 14 shows an exemplary product forming system 106 in the prior art for forming the expansion joint 18(5). In this embodiment, product forming system 106 comprises an extruder 108 having a generally conventional configuration which produces the foam profile 102 in any desired configuration having side edges 110 and 112. Puller 114 may be employed for continuously drawing the foam profile 102 from extruder 108 and feeding the foam profile 102 to a tube forming machine 116. In employing the product forming system 106, any polyolefin material may be used to form the foam profile 102. However, the preferred polyolefin material comprises one or more selected from the group consisting of polystyrenes, polyolefins, polyethylenes, polybutanes, polybutylenes, polyurethanes, thermoplastic elastomers, thermoplastic polyesters, thermoplastic polyurethanes, polyesters, ethylene acrylic copolymers, ethylene vinyl acetate copolymers, ethylene methyl acrylate copolymers, ethylene butyl acrylate copolymers, ionomers polypropylenes, and copolymers of polypropylene.

The tube forming machine 116 is constructed for receiving the foam profile 102 on rotating mandrel 118 in a manner which causes the foam profile 102 to be wrapped around the rotating mandrel 118 of tube forming machine 116 continuously, forming a plurality of helically-wrapped convolutions 120 in a side-to-side abutting relationship. In this way, the incoming continuous feed of the foam profile 102 may be automatically rotated about mandrel 118 in a generally spiral configuration, causing side edge 110 of the foam profile 102 to be brought into abutting contact with the side edge 112 of previously received and helically-wrapped convolution 120. By bonding the side edges 110, 112 to each other at this juncture point, the expansion joint 18(5) may be formed substantially cylindrical and hollow. In order to provide integral bonded engagement of side edge 110 of the foam profile 102 with the side edge 112 of the helically-wrapped convolution 120, a bonding fusion head 122 may be employed. If desired, the bonding fusion head 122 may comprise a variety of alternate constructions in order to attain the desired secure affixed bonded inter-engagement of the side edge 110 with the side edge 112. In the preferred embodiment, the bonding fusion head 122 employs heated air.

By delivering heated air to the bonding fusion head 122, a temperature of the bonding fusion head 122 is elevated to a level that enables the side edges 110, 112 of the foam profile 102 and the helically-wrapped convolution 120 which contacts the bonding fusion head 122, to be raised to their melting point and thus may be securely fused or bonded to each other. The bonding fusion head 122 may be positioned at the juncture zone at which side edge 110 of the foam profile 102 is brought into contact with the side edge 112 of the previously received and the helically-wrapped convolution 120. By causing the bonding fusion head 122 to simultaneously contact the side edge 110 and the side edge 112 of these components of the foam profile 102, the temperature of the surfaces is raised to the melting point thereof, thus enabling the contact of the side edge 110 of the foam profile 102 which is incoming to be brought into direct contact with side edge 112 of a first one of the helically-wrapped convolution 120 in a manner which causes the surfaces to be intimately bonded to each other. Although heated air is preferred for this bonding operation, alternate affixation means may be employed. One such alternative is the use of heated adhesives applied directly to the side edges 110, 112. A cutting system 124, including a heated wire 126, may cut the expansion joint 18(5) at an angle, for example, perpendicular, to the center axis of the mandrel 118. In this manner, the expansion joint 18(5) may be created.

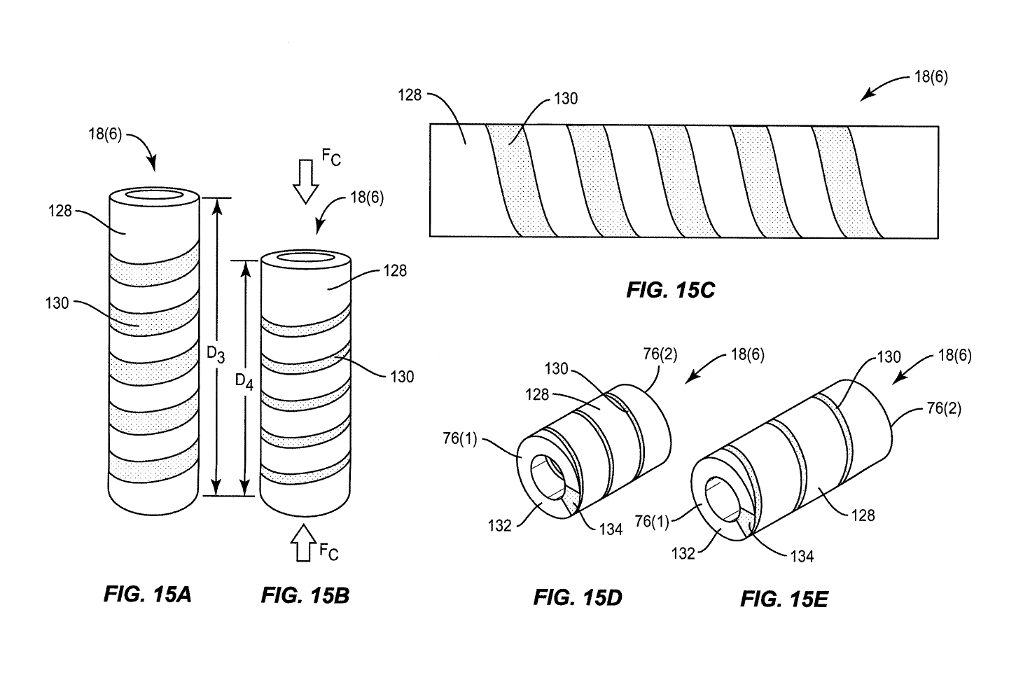

There are other examples of expansion joints that may be provided to ensure that the gap 22 between the insulation members 16(1), 16(2) is fully insulated. FIGS. 15A-15D depict views of another embodiment of an expansion joint 18(6) which may illustrate another example of the expansion joint 18(1). The expansion joint 18(6) may operate similarly to the expansion joint 18(1) of FIG. 8B, as discussed previously and so only the differences will be discussed for clarity and conciseness. The expansion joint 18(6) may comprise a first insulation section 128 and a second insulation section 130 embedded within the first insulation section 128 in a helical shape. The helical shape enables the first insulation section 128 and the second insulation section 130 to be efficiently combined with each other in a single embodiment of the expansion joint 18(6). In this manner, the expansion joint 18(6) may include performance characteristics of both the first insulation section 128 and the second insulation section 130.

To take advantage of a benefit of having multiple performance characteristics, the first insulation section 128 may comprise a different material than the second insulation section 130. The first insulation section 128 may be more stiff and a higher density to provide strength to the expansion joint 18(6). The second insulation section 130 may be made of a more resilient and less stiff material than the first insulation section to make it easier to compress the expansion joint 18(6) during installation within the gap 22.

FIGS. 15A and 15B are perspective views of the expansion joint 18(6) in an uncompressed state having an exemplary length of D₃ of fourteen (14) inches long and in a compressed state having an exemplary length D₄ of eleven (11) inches long when subject to a compressive force F_{C}, respectively. Most or all of the initial contraction may occur in the second insulation section 130 as shown when FIGS. 15A and 15B are compared. FIG. 15C is a side view of the expansion joint 18(6) of FIG. 15A in an uncompressed state, illustrating the helical shape of the first insulation section 128 and the helical shape of the second insulation section 130.

FIGS. 15D and 15E are perspective views of the expansion joint 18(6) illustrating end surfaces 76(1), 76(2) of the expansion joint 18(6) after cutting, as part of an exemplary manufacturing process. The end surfaces 76(1), 76(2) may comprise a portion 132 of the first insulation section 128 and a portion 134 of the second insulation section 130. The portion 132 and the portion 134 form a planar surface at the end surfaces 76(1), 76(2), which may provide a continuous surface to fully abut against the abutment surfaces 22(1), 22(2) of the insulation members 16(1), 16(2), respectively.

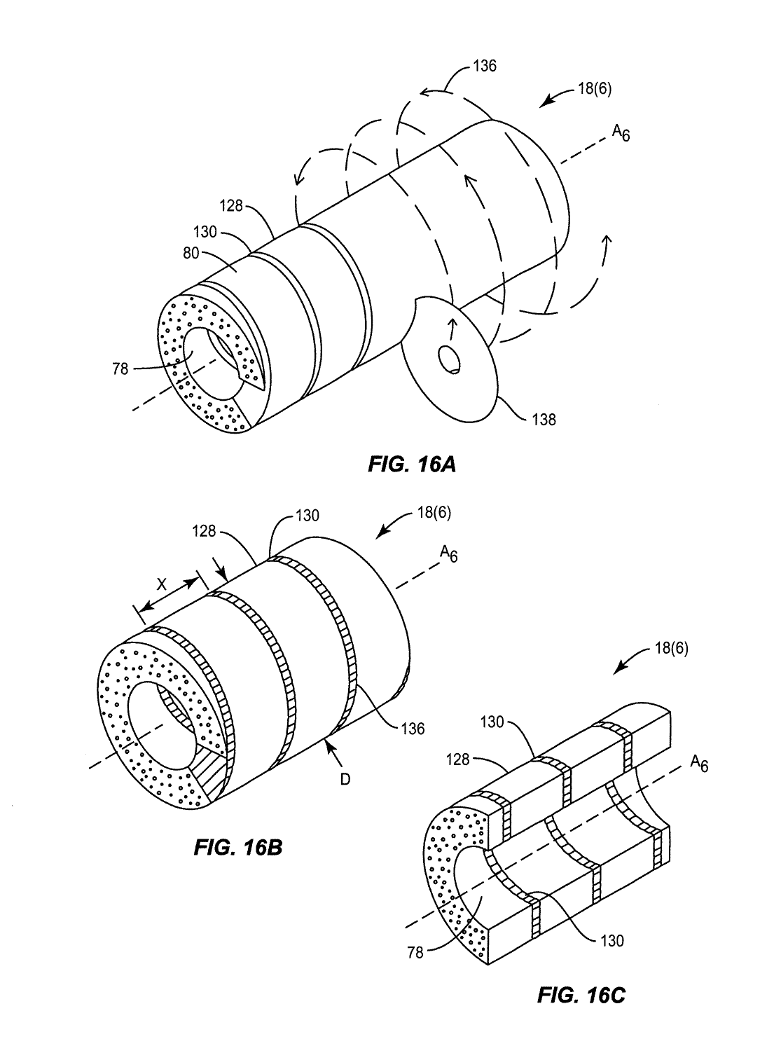

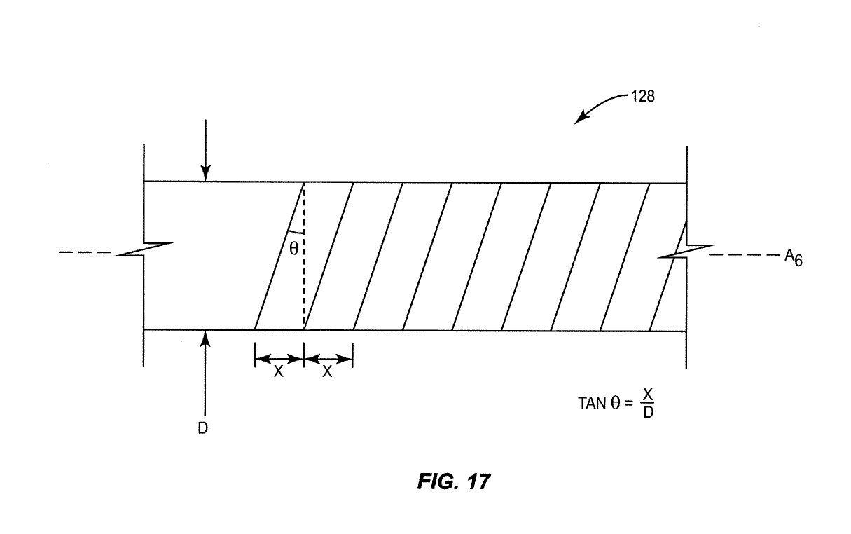

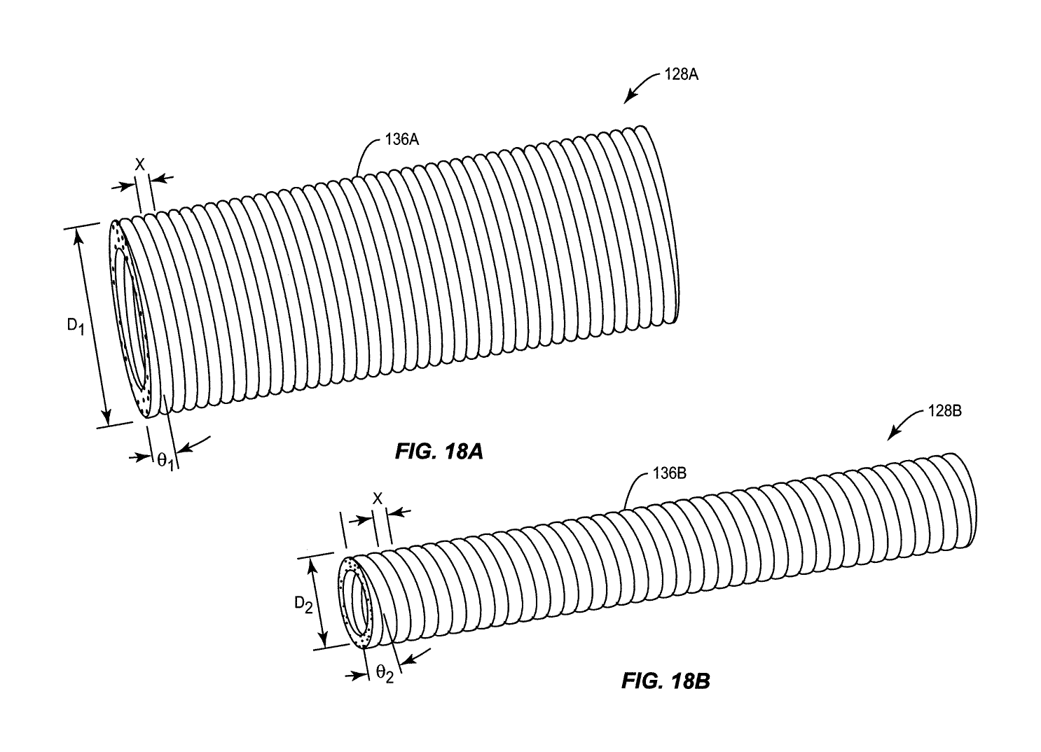

FIGS. 16A-16C depict an exemplary process for creating the expansion joint 18(6). First, the first insulation section 128 may be cut fully through from the external surface 80 to the internal surface 34 along a helical path 136 with a cutter 138, as shown in FIG. 16A. The cutter 138 may be, for example, a rotary saw. A tangent to any point along the helical path 136 makes a pitch angle theta (θ) (FIG. 17) with the center axis A₆ of the expansion joint 18(6). The pitch angle theta (θ) may be calculated as the arctangent of VD. In this calculation, X may be a pitch distance X parallel to the center axis A₆ of spiral convolution, including a contribution from the first insulation section 128 and the second insulation section 130. Further, D may be the diameter D of the first insulation section 128 as shown in FIG. 16B and FIG. 17.

Next, as shown in FIG. 16B, the second insulation section 130 is disposed within the helical path 136. FIG. 16C depicts a partial perspective view of the expansion joint 18(6) showing the second insulation section 130 in the internal surface 78, which allows longitudinal expansion along the center axis A₆.

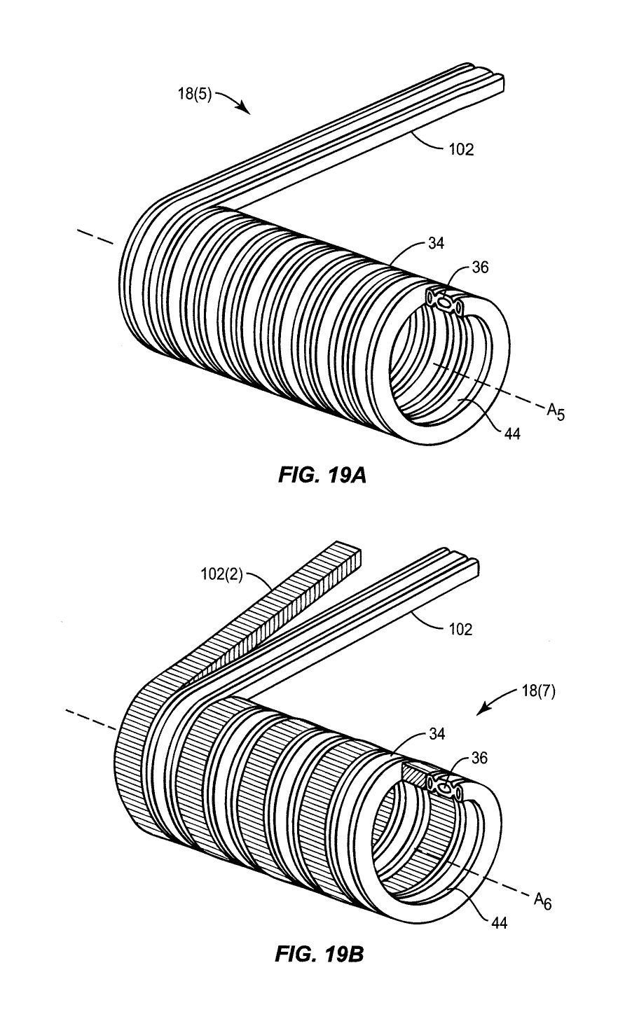

The relationship between diameter D and helical pitch angle (θ) for a constant pitch distance X is best shown by visual examples. FIGS. 18A and 18B are perspective views of one example of a first insulation section 128A and another example of a first insulation section 128B having helical pitch angles theta (θ₁, θ₂) as a function of diameters D₁, D₂, respectively, for helical paths 136A, 136B having identical values of the pitch distance X. As the pitch distance X remains constant, the pitch angle theta (θ₂) will be larger for FIG. 18B than the pitch angle theta (θ₁) of FIG. 18A because the diameter D₂ is smaller than D₁ which creates a larger ratio X/D and thereby a larger arctangent (X/D). The pitch angle theta (θ) may be preferably less than twenty (20) degrees to maximize contraction of the expansion joint 18(6) along the center axis A₆. Consequently, the pitch distance X of the foam profile 102 may need to be reduced to result in a small pitch angle theta (θ) less than twenty (20) degrees, for examples of the pipes 12 having relatively small dimensions of the diameter D.

Now that the concept of the first insulation section 128 and the second insulation section 130 have been discussed in the helical shapes that are combined to form the expansion joint 18(6), other examples of expansion joints are possible. In this regard, expansion joints 18(5), 18(7) having a single profile and dual profiles, respectively, are now discussed.

FIG. 19A is a view of the expansion joint 18(5) formed with the product forming system 106 of FIG. 14. The expansion joint 18(5) may comprise the single foam profile 102. The single foam profile 102 may be relatively complex and engineered to give precise compression characteristics with shaped ones of the inner passageway 36, the outer channels 34, and the inner channels 44. FIG. 19B depicts an expansion joint 18(7) which may illustrate another example of the expansion joint 18(1). The expansion joint 18(7) may operate similar to the expansion joint 18(1) of FIG. 2B, as discussed previously, and so only differences will be discussed for clarity and conciseness.

The expansion joint 18(7) may comprise the single foam profile 102 shown in FIG. 13A and a second foam profile 102(2). The foam profile 102 may include the outer channels 34, the inner channels 44, and optionally the at least one inner passageway 36, which may reduce the stiffness of the expansion joint 18(7). The reduction of stiffness may allow the expansion joint 18(7) to more easily fit within the gap 22 between the insulation members 16(1), 16(2) of FIG. 2A. The second foam profile 102(2) may be denser than the foam profile 102(2) to provide strength to the expansion joint 18(7). In this manner, the expansion joint 18(7) may provide the compression performance needed to provide full insulation between the insulation members 16(1), 16(2) of FIG. 2B during thermal cycling of the insulation members 16(1), 16(2), and may also provide strength needed, for example, for rugged applications such as an oil pipeline operating all year long that is located, for example, north of the Arctic Circle.

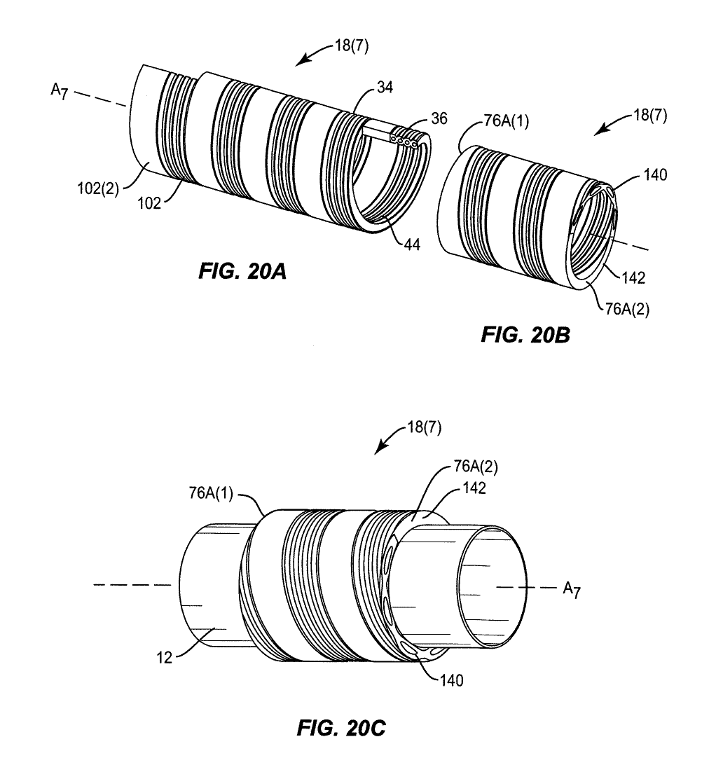

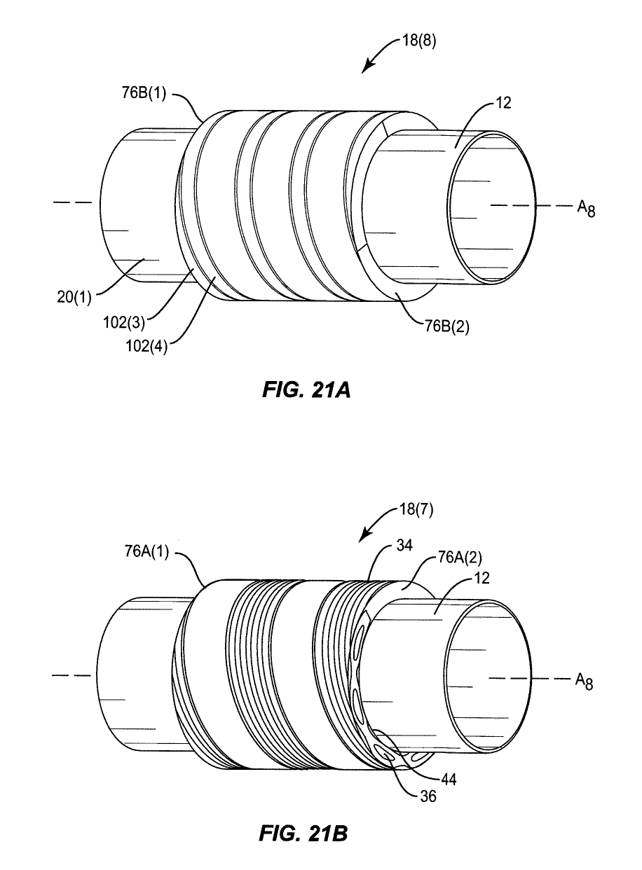

FIGS. 20A and 20B depict the expansion joint 18(7) after thermal bonding between the foam profile 102 and the second foam profile 102(2) and after cutting to make end surfaces 76A(1), 76A(2) orthogonal to the center axis A₇. The end surfaces 76A(1), 76A(2) comprise a portion 140 of the foam profile 102 and a portion 142 of the second foam profile 102(2). The portion 140 may be non-uniform around the end surfaces 76A(1), 76A(2) because of the outer channels 34, the inner channels 44, and the at least one inner passageway 36. FIG. 20C depicts a perspective view of the expansion joint 18(7) disposed around the pipe 12.

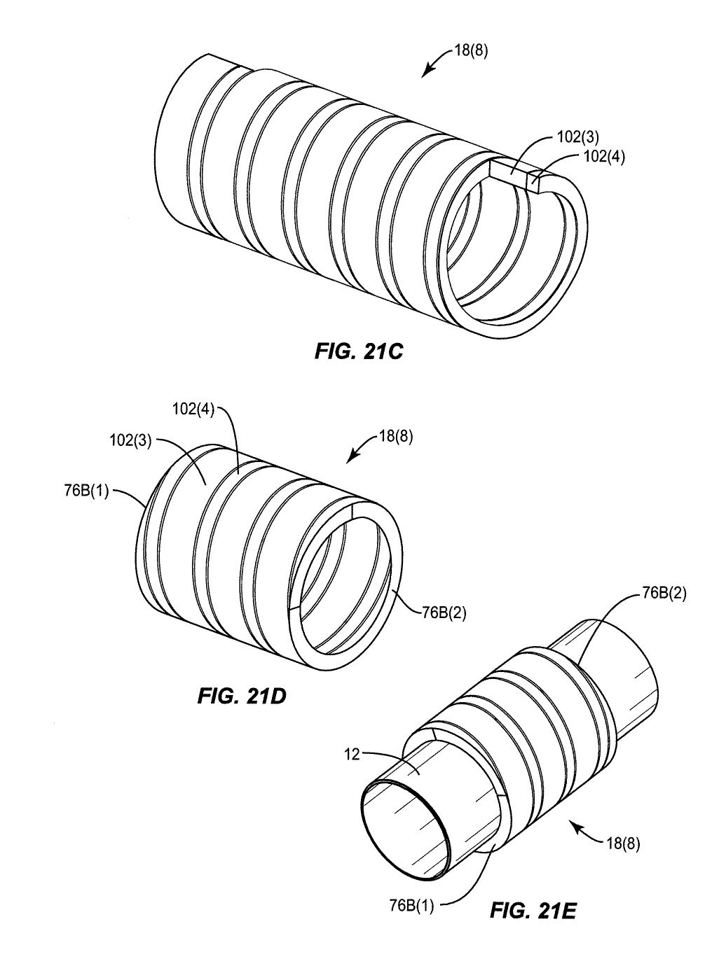

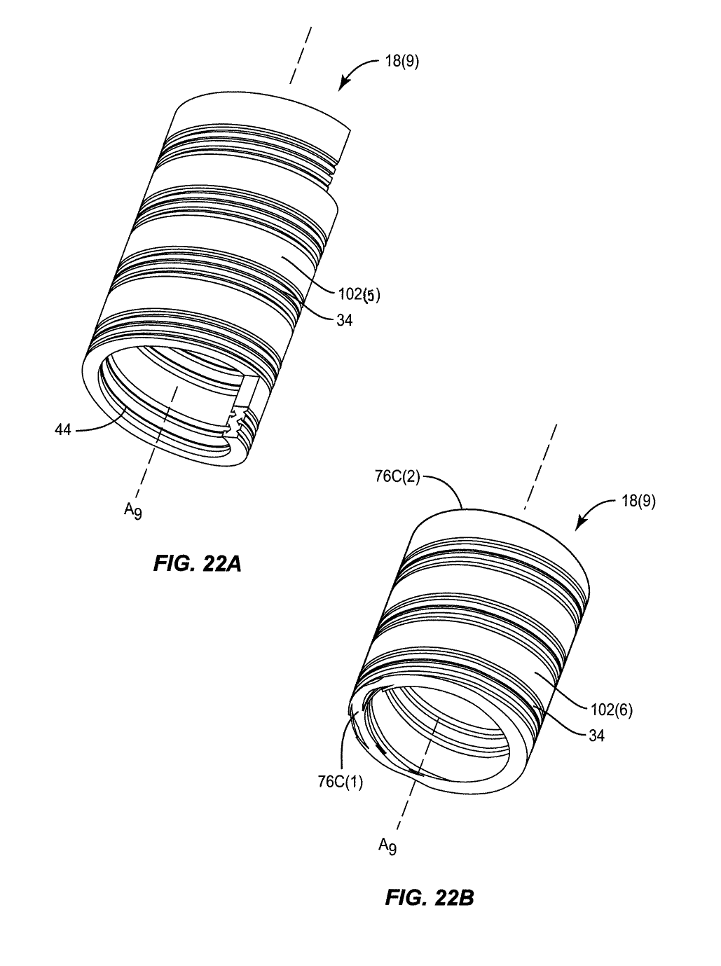

FIG. 21A is a perspective view of an expansion joint 18(8) which may be another example of the expansion joint 18(1). The expansion joint 18(8) may operate similar to the expansion joint 18(1) of FIG. 2B, as discussed previously, and so only differences will be discussed for clarity and conciseness. The expansion joint 18(8) may comprise a foam profile 102(3) and a foam profile 102(4). Neither the foam profile 102(3) nor the foam profile 102(4) include outer channels 34, inner channels 44, or inner passageways 36. As a result, end surfaces 76B(1), 76B(2) are smooth and uniform about the center axis A₈. Smooth and uniform examples of the end surfaces 76B(1), 76B(2) may better insulate the gap 22 between the insulation members 16(1), 16(2) that is shown in FIG. 8B. FIG. 21B depicts a perspective view of the expansion joint 18(7) of FIG. 20C to present the end surfaces 76A(1), 76A(2) of FIG. 21B for comparison, which are not smooth and have openings related to the inner channels 44, the outer channels 34, and the inner passageways 36. FIGS. 21C-21E are additional perspective views of the expansion joint 18(8) of FIG. 21A, including before cutting to form the end surfaces 76B(1), 76B(2), after forming the end surfaces 76B(1), 76B(2), and after installation on the pipe 12, respectively. In applications where the expansion joint 18(7) may need to be compressed during installation on a pipe 12, then the reduced stiffness may be achieved with geometry and/or material selection.

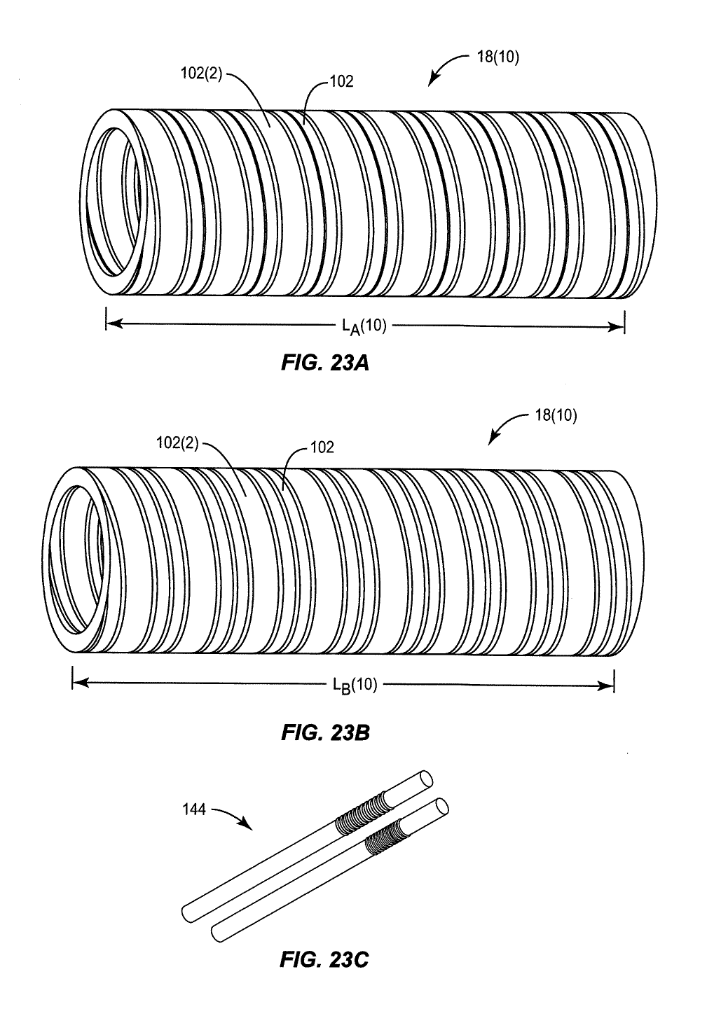

FIGS. 22A and 22B are perspective views of another embodiment of an expansion joint 18(9) before end surfaces 76C(1), 76C(2) are formed, and after the end surfaces 76C(1), 76C(2) are formed, respectively. The expansion joint 18(9) may operate similar to the expansion joint 18(1) of FIG. 8B, as discussed previously, and so only differences will be discussed for clarity and conciseness. The expansion joint 18(9) may comprise a foam profile 102(5) and a foam profile 102(6). The foam profile 102(5) may include outer channels 34 and inner channels 44, but is free of the inner passageways 36. As a result of not having inner passageways 36, the end surfaces 76C(1), 76C(2) are relatively smooth and uniform about the center axis A₉. Smoother and more uniform examples of the end surfaces 76C(1), 76C(2) of the expansion joint 18(9) may be better able to uniformly abut against the insulation members 16(1), 16(2) of FIG. 2A, compared to the less uniform examples of the end surfaces 76A(1), 76A(2) of the expansion joint 18(7). In this regard, the expansion joint 18(9) may be better able to fully insulate the gap 22 between the insulation members 16(1), 16(2) shown in FIG. 8A.

In another example shown in FIGS. 23A and 23B, an expansion joint 18(10) may be formed that may be factory compressed and annealed at an elevated temperature, so that a compression of the expansion joint 18(10) during installation around the pipe 12 may be reduced or eliminated to make installation more convenient. In this example, expansion joint 18(10) includes foam profiles 102 and 102(2), described above with respect to FIG. 19A. In this example, when the exterior surface 14 of the pipe 12 reaches an operating temperature, the insulation members may pull on the expansion joint to an expanded length during expansion to cover the increased gap 22 between the insulation members 16(1), 16(2). When operation of the pipe 12 may be turned off, the insulation members 16(1), 16(2) (see FIG. 2A) may expand again and the expansion joint 18(10) may contract to an original, pre-compressed state.

In this regard, the factory-compression may be added to an expansion joint to reduce the requirement to compress the expansion joint during installation. FIG. 23A-23B are side views of an expansion joint 18(10), which may another example of the expansion joint 18(1). The expansion joint 18(10) may operate similarly to the expansion joint 18(1) of FIG. 2B, as discussed previously, thus only the difference will be discussed for clarity and conciseness. Prior to installation onto a pipe 12, the expansion joint 18(7) shown in FIG. 20C may be fully compressed parallel to the center axis A₇ to a length L_{A}(10) so that any and all outer channels 34, inner channels 44, and inner passageways 36 are closed. Then the expansion joint 18(7) may be placed in an annealing oven at an elevated temperature to thermally form the expansion joint 18(7) in that position to form expansion joint 18(10) of FIGS. 23A and 23B. The expansion joint 18(10) may be installed within the gap 22 without requiring compression. For example, if the gap 22 is ten (10) inches long, then the expansion joint 18(10) which is also ten (10) inches long in length L_{A}(10) may be installed and attached to the abutment surfaces 22(1), 22(2) of the insulation members 16(1), 16(2) with the attachment members 74(1), 74(2). When the external surface 14 of the pipe 12 reaches the operating temperature T_{O}, then the insulation members 16(1), 16(2) may contract and the gap 22 may increase to the distance D₁(2). However, the attachment members 74(1), 74(2), with the assistance of fasteners, may pull the expansion joint 18(10) to fill the gap 22 and maintain insulation within the gap 22. FIG. 23B shows the expansion joint 18(10) pulled to an expanded length L_{B}(10) as would be experienced in operation to fill the gap 22. The pulling to expand the expansion joint 18(10) may be analogous to pulling a flexible example of a soda straw 144 to an elongated position as shown in FIG. 23C. As the pipe 12 eventually reaches ambient temperature, then the insulation members 16(1), 16(2) in FIG. 2A would expand and the expansion joint 18(10) would contract to the distance D₁(1) in FIG. 2A.

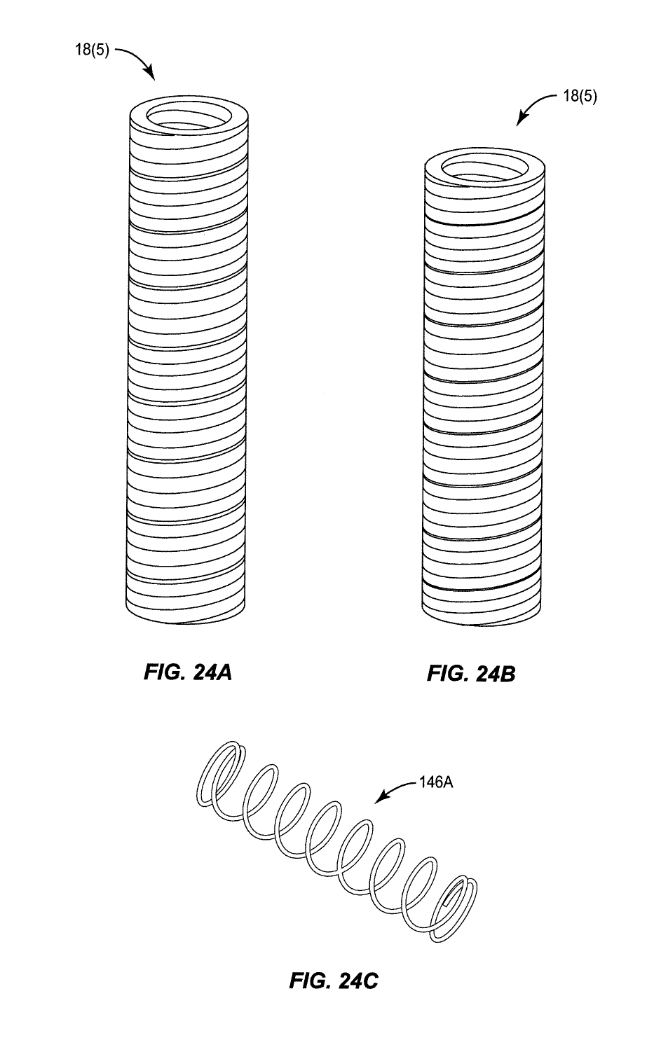

Other examples of expansion joints are possible. As a comparison, FIGS. 24A and 24B depict perspective views of the expansion joint 18(5) shown in FIG. 13A in an expanded and a compressed state, respectively. The expansion joint 18(5) may be mechanically analogized to a helical spring 146A, which may be metal, as shown in FIG. 18C wherein the expansion joint 18(5) pushes against the insulation members 16(1), 16(1) even when the pipe 12 is at ambient temperature, because the expansion joint 18(5) has a natural length D₂(1) longer than the distance D₁(1) of the gap 22.

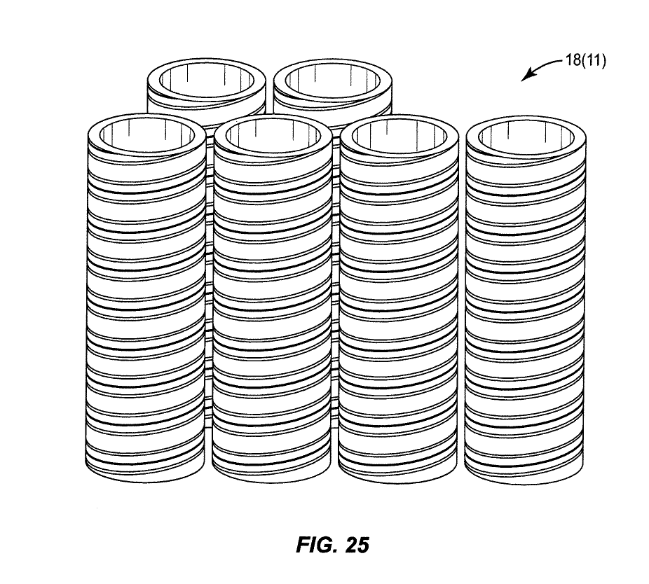

It is noted that prior to installation onto a pipe 12, the expansion joint 18(7) shown in FIG. 20B may be partially compressed parallel to the center axis A₇ so that any and all outer channels 34, inner channels 44, and inner passageways 36 are partially closed. Then the expansion joint 18(7) may be placed in an annealing oven at an elevated temperature to thermally form the expansion joint 18(7) in that position to form an expansion joint 18(11), as shown in a perspective view of a group of the expansion joints 18(11) in FIG. 25. The expansion joint 18(11) is installed within the gap 22 with minimal compression. For example, if the gap 22 is ten (10) inches long, then the expansion joint 18(11) of eleven (11) inches long may be installed and attached to the abutment surfaces 22(1), 22(2) of the insulation members 16(1), 16(2) with the attachment members 74(1), 74(2). When the external surface 14 of the pipe 12 reaches the operating temperature T_{O}, then the insulation members 16(1), 16(2) may contract and the gap 22 may increase to the distance D₁(2). However, the attachment members 74(1), 74(2) may pull the expansion joint 18(10) to fill the gap 22 and maintain insulation within the gap 22.

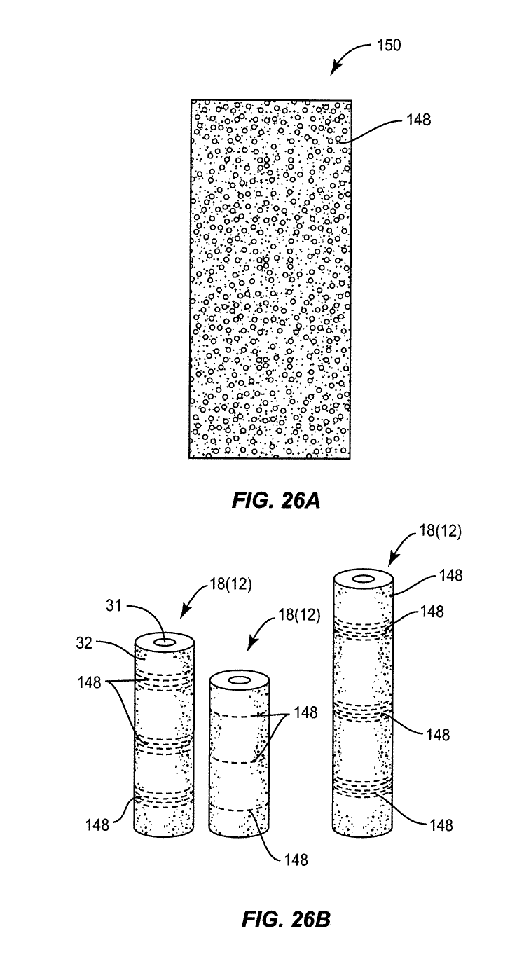

Other examples of an expansion joint are possible. FIG. 26A shows that pinning or puncturing holes 148 may be added to a foamed polyolefin member 150 to provide enhanced compressibility. The foamed polyolefin member 150 may contain material used to make any of the earlier mentioned expansion joints. Pinning or puncturing holes 148 may be added to any one of the previous examples of expansion joints to form an elongated joint 18(12) with enhanced compressibility by reducing stiffness or resistance to compression or tension, as shown in FIG. 26B. The pinning or puncturing holes 148 may extend into the expansion joint 18(12) from the external surface 80 to a predetermined depth of at least ten (10) percent of a thickness of the expansion joint 18(12). The enhanced compressibility may enable the attachment members 74(1), 74(2) to more easily move the elongated joint 18(12) to fill the gap 22.

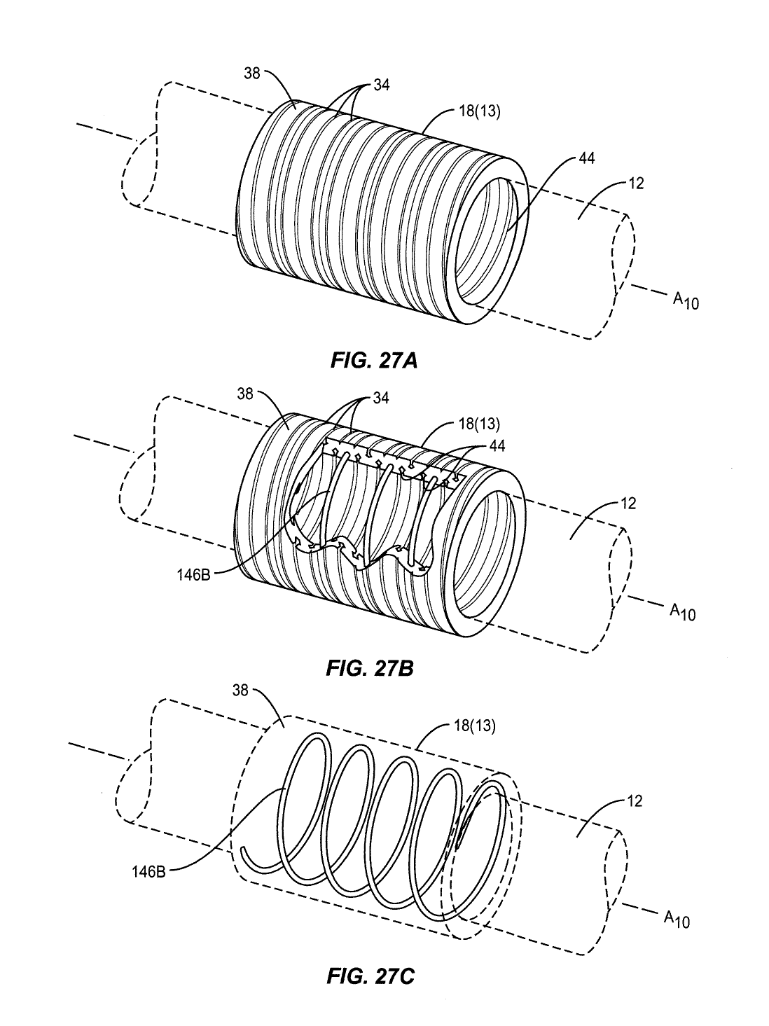

Other examples of expansion joints are possible. FIGS. 27A-27C are a perspective view, a partial cutaway perspective view and a full cutaway view, respectively, of an exemplary expansion joint 18(13) installed upon the pipe 12. The expansion joint 18(13) comprises a foam expansion body 38 and a helical spring 146B disposed within the foam expansion body 38. The foam expansion body 38 may be structurally similar to the expansion joints 18(1)-18(12) discussed earlier, and accordingly only differences will be discussed for clarity and conciseness. As shown in FIG. 27A, the expansion joint 18(13) may appear similar to the expansion joints 18(1)-18(12) as only the foam expansion body 38 is observable from the outside. As depicted in the partial cutaway view of FIG. 27B, the foam expansion body 38 of the expansion joint 18(13) may comprise the outer channels 34 and the inner channels 44. The foam expansion body 38 may also optionally include the inner passageways 36 (not shown in FIG. 27B). The helical spring 146B may be disposed within the foam expansion body 38 of the expansion joint 18(13). For example, the helical spring 146B may be disposed within the outer channels 34, the inner channels 44, or within the inner passageway 36. Accordingly as the foam expansion body 38 is placed in compression or tension parallel to the center axis A10 by the change in the gap 22 between the insulation members 16(1), 16(2) shown in FIG. 8A. The helical spring 146B will also correspondingly be placed in compression or tension parallel to the center axis A10. In this manner, the helical spring 146B provides resiliency to the expansion joint 18(13) so that the end surfaces 76(1), 76(2) of the expansion joint 18(13) may better push against the insulation members 16(1), 16(2) shown in FIG. 8A, to ensure that the gap 22 (FIG. 8A) is fully insulated.

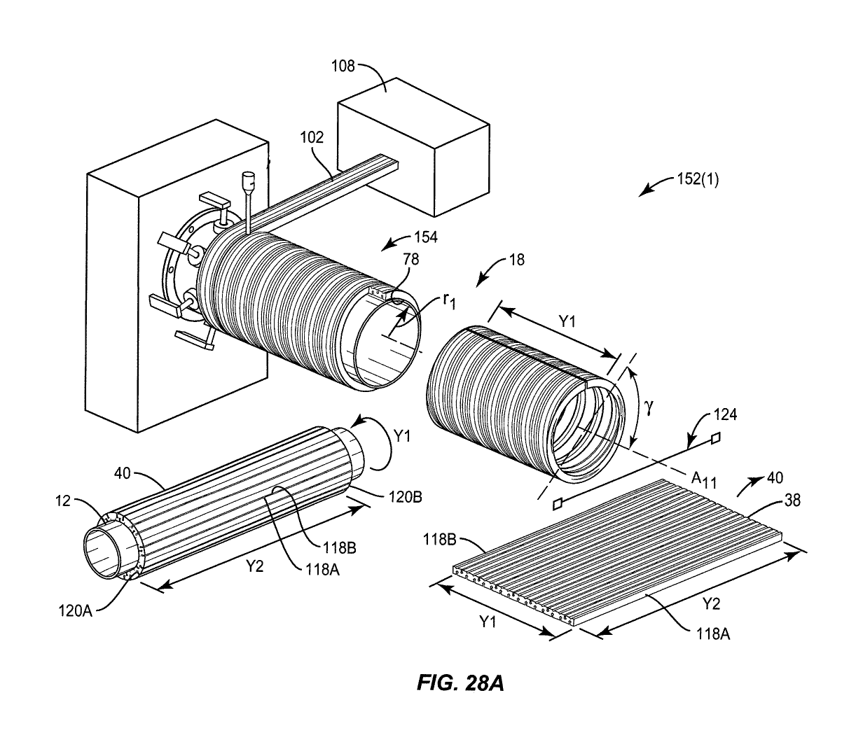

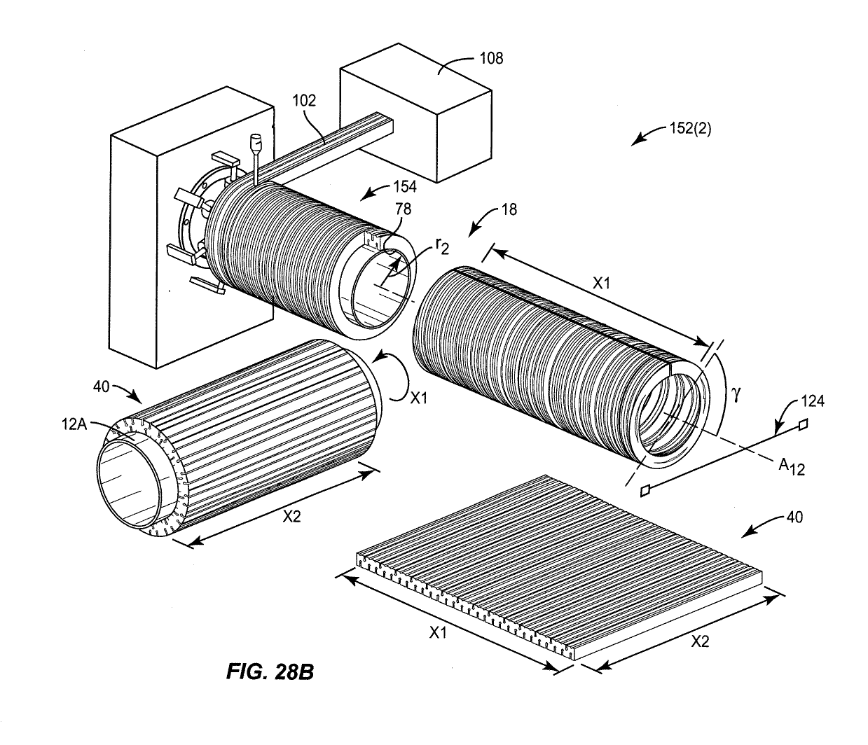

An exemplary process 152(1) for creating the insulation wrap 40(2) is depicted graphically in FIG. 28A, similar in some ways to the exemplary process (FIG. 14) to make the expansion joints 18(1)-18(13). The process 152(1) comprises extruding the at least one foam profile 102 through the extruder 108. The extruding may comprise forming the at least one outer channel 34 and the at least one inner channel 44 as part of the foam profile 102. The process 152(1) further comprises positioning the at least one foam profile 102 each with a helical shape 154 configured to be disposed around the elongated container 12. The helical shape 154 may be positioned about the center axis A₁₁ and the internal surface 78 of the at least one foam profile 102 are disposed a common distance r₁ from the center axis A₁₁. The process 152(1) may also include thermally bonding with the bonding fusion head 122 the plurality of convolutions of the helical shape 154, as discussed above. In this manner, the foam expansion body 38 may be formed.

The process 152(1) further comprises cutting the at least one foam profile 102 at an angle gamma (γ) to the center axis A₁₁ with the cutting system 124 to form the first longitudinal side 39A and the second longitudinal side 39B of the insulation wrap 40. The angle gamma (γ) may be, for example, ninety (90) degrees. The process 152(1) further comprises cutting the at least one foam profile 102 to form the first latitudinal side 41A and the second latitudinal side 41B of the insulation wrap 40. In this manner, the insulation wrap 40 may fit upon the elongated container 12.

FIG. 28B depicts a similar process to FIG. 28A for creating the insulation wrap 40, and so only differences will be discussed for clarity and conciseness. In the process 152(2), the helical shape 154 may be positioned about the center axis A₁₂, and the internal surface 78 of the at least one foam profile 102 is disposed a common distance r₂ from the center axis A₁₂. The common distance r₂ may be longer than the common distance r₁ to create the first longitudinal side 39A and the second longitudinal side 39B of length X₂, which may be longer than the comparable length Y₂ in FIG. 24A. Further, the foam profile 102 may be cut a longer length X₁ by the cutting system 124 in the process 152(2) to be mounted on an elongated container 12A having a larger diameter than the elongated container 12 in the process 152(1). In this manner, the insulation wraps 40 of different sizes may be created.

Many modifications and other variations of the embodiments disclosed herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. An elongated fastener for retaining an insulation wrap around an elongated container comprising:
a substantially flat fastener body configured to extend along at least one seam formed by first and second longitudinal sides of the insulation wrap when the insulation wrap is disposed around the elongated container, and further configured to span the at least one seam, the fastener body having a first longitudinal edge and a second longitudinal edge;
a first rail extending from the first longitudinal edge of the fastener body and configured to be inserted into a first longitudinal slot in the insulation wrap extending proximate to and parallel to the first longitudinal side, the first rail having at least one protrusion for engaging an interior surface of the first longitudinal slot, thereby retaining the first rail in the first longitudinal slot; and
a second rail extending from the second longitudinal edge of the fastener body and configured to be inserted into a second longitudinal slot in the insulation wrap extending proximate to and parallel to the second longitudinal side, the second rail having at least one protrusion for engaging an interior surface of the second longitudinal slot, thereby retaining the second rail in the second longitudinal slot.

2. The elongated fastener of claim 1, wherein the at least one protrusion comprises a rail extending perpendicular to an outer surface of each of the first and second rails.

3. The elongated fastener of claim 1, wherein the at least one protrusion comprises a plurality of protrusions extending from opposite sides of each of the first and second rails.

4. The elongated fastener of claim 3, wherein each of the first and second rails has two parallel protrusions extending perpendicular from each of the opposite sides along an entire length of each of the first and second rails.

5. The elongated fastener of claim 1, wherein the fastener is made of metal.

6. The elongated fastener of claim 1, wherein the fastener is made of plastic.

7. The elongated fastener of claim 6, wherein the fastener is made of thermoplastic.

8. A method of retaining an insulation wrap around an elongated container comprising:
disposing an insulation wrap around an elongated container extending in a longitudinal direction such that a first longitudinal side of the insulation wrap is disposed adjacent to a second longitudinal side of the insulation wrap, thereby forming at least one seam along a longitudinal direction;
fastening the first and second longitudinal sides of the insulation wrap via an elongated fastener comprising:
a substantially flat fastener body configured to extend along the at least one seam, the fastener body having a first longitudinal edge and a second longitudinal edge;
a first rail extending from the first longitudinal edge of the fastener body, wherein fastening the first and second longitudinal sides includes inserting the first rail into a first longitudinal slot in the insulation wrap extending proximate to and parallel to the first longitudinal side, the first rail having at least one protrusion engaging an interior surface of the first longitudinal slot, thereby retaining the first rail in the first longitudinal slot; and
a second rail extending from the second longitudinal edge of the fastener body, wherein fastening the first and second longitudinal sides includes inserting the second rail into a second longitudinal slot in the insulation wrap extending proximate to and parallel to the second longitudinal side, the second rail having at least one protrusion engaging an interior surface of the second longitudinal slot, thereby retaining the second rail in the second longitudinal slot.

9. The method of claim 8, wherein the elongated fastener and the seam of the insulation wrap have equal lengths.

10. The method of claim 8, wherein the elongated fastener is disposed along the seam such that at least a portion of the elongated fastener extends beyond a distal end of the seam.

11. The method of claim 10, wherein the insulation wrap is a first insulation wrap, the method further comprising fastening a portion of a seam of an adjacent insulation wrap with the portion of the elongated fastener that extends beyond the distal end of the seam of the first insulation wrap.

12. The method of claim 8, wherein the at least one protrusion comprises a rail extending perpendicular to an outer surface of each of the first and second rails.

13. The method of claim 8, wherein the at least one protrusion comprises a plurality of protrusions extending from opposite sides of each of the first and second rails.

14. The method of claim 8, wherein the fastener is made of metal.

15. The method of claim 8, wherein the fastener is made of plastic.

16. The method of claim 15, wherein the fastener is made of thermoplastic.

17. The method of claim 8, wherein the insulation wrap is a first insulation wrap, the elongated fastener is a first elongated fastener, and the method further comprising:
disposing a second insulation wrap around the first insulation wrap extending in a longitudinal direction such that a first longitudinal side of the insulation wrap is disposed adjacent to a second longitudinal side of the insulation wrap, thereby forming at least one seam along a longitudinal direction;
fastening the first and second longitudinal sides of the insulation wrap via an elongated fastener comprising:
a substantially flat fastener body configured to extend along the at least one seam, the fastener body having a first longitudinal edge and a second longitudinal edge;
a first rail extending from the first longitudinal edge of the fastener body, wherein fastening the first and second longitudinal sides includes inserting the first rail into a first longitudinal slot in the second insulation wrap extending proximate to and parallel to the first longitudinal side, the first rail having at least one protrusion engaging an interior surface of the first longitudinal slot, thereby retaining the first rail in the first longitudinal slot; and
a second rail extending from the second longitudinal edge of the fastener body, wherein fastening the first and second longitudinal sides includes inserting the second rail into a second longitudinal slot in the second insulation wrap extending proximate to and parallel to the second longitudinal side, the second rail having at least one protrusion engaging an interior surface of the second longitudinal slot, thereby retaining the second rail in the second longitudinal slot.

18. The method of claim 17, further comprising rotationally offsetting the at least one seam of the second insulation wrap from the seam of the first insulation wrap.

19. The method of claim 8, further comprising disposing a barrier layer around the first insulation wrap.

20. An insulation system for an exterior of an elongated container, comprising:
an insulation wrap configured to be disposed around an elongated container, the insulation wrap extending from a first longitudinal side to a second longitudinal side opposite the first longitudinal side, and the insulation wrap extending from the first longitudinal side to the second longitudinal side opposite the first longitudinal side;
a first longitudinal slot in the insulation wrap extending proximate to and parallel to the first longitudinal side;
a second longitudinal slot in the insulation wrap extending proximate to and parallel to the second longitudinal side;
at least one seam extending from the first longitudinal side to the second longitudinal side; and
at least one longitudinal fastener configured to fasten the first longitudinal side proximate to the second longitudinal side to secure the insulation wrap in a shape or substantially the shape of a cross-sectional perimeter of the elongated container, the at least one longitudinal fastener comprising:
a substantially flat fastener body configured to extend along the at least one seam and further configured to span the at least one seam, the fastener body having a first longitudinal edge and a second longitudinal edge;
a first rail extending from the first longitudinal edge of the fastener body and configured to be inserted into the first longitudinal slot, the first rail having at least one protrusion for engaging an interior surface of the first longitudinal slot, thereby retaining the first rail in the first longitudinal slot; and
a second rail extending from the second longitudinal edge of the fastener body and configured to be inserted into the second longitudinal slot, the second rail having at least one protrusion for engaging an interior surface of the second longitudinal slot, thereby retaining the second rail in the second longitudinal slot.

21. The system of claim 20, wherein the elongated fastener and the seam of the insulation wrap have equal lengths.

22. The system of claim 20, wherein the elongated fastener is disposed along the seam such that at least a portion of the elongated fastener extends beyond a distal end of the seam.

23. The system of claim 22, wherein the insulation wrap is a first insulation wrap, the system further comprising a second insulation wrap disposed around the elongated container adjacent to the first insulation wrap, wherein at least a portion of a seam of the second insulation wrap is fastened with the portion of the elongated fastener that extends beyond a distal end of the seam of the first insulation wrap.

24. The system of claim 20, wherein the at least one protrusion comprises a rail extending perpendicular to an outer surface of each of the first and second rails.

25. The system of claim 20, wherein the at least one protrusion comprises a plurality of protrusions extending from opposite sides of each of the first and second rails.

26. The system of claim 20, wherein the fastener is made of metal.

27. The system of claim 20, wherein the fastener is made of plastic.

28. The system of claim 27, wherein the fastener is made of thermoplastic.

29. The system of claim 20, wherein the insulation wrap is a first insulation wrap, the elongated fastener is a first elongated fastener, and the system further comprising:
a second insulation wrap configured to be disposed around the first insulation wrap, the second insulation wrap extending from a first longitudinal side to a second longitudinal side opposite the first longitudinal side, and the insulation wrap extending from the first longitudinal side to the second longitudinal side opposite the first longitudinal side;
a first longitudinal slot in the second insulation wrap extending proximate to and parallel to the first longitudinal side;
a second longitudinal slot in the second insulation wrap extending proximate to and parallel to the second longitudinal side;
at least one seam extending from the first longitudinal side to the second longitudinal side; and
at least one longitudinal fastener configured to fasten the first longitudinal side proximate to the second longitudinal side to secure the second insulation wrap in a shape or substantially the shape of a cross-sectional perimeter of the elongated container, the at least one longitudinal fastener comprising:
a substantially flat fastener body configured to extend along the at least one seam and further configured to span the at least one seam, the fastener body having a first longitudinal edge and a second longitudinal edge;
a first rail extending from the first longitudinal edge of the fastener body and configured to be inserted into the first longitudinal slot, the first rail having at least one protrusion for engaging an interior surface of the first longitudinal slot, thereby retaining the first rail in the first longitudinal slot; and
a second rail extending from the second longitudinal edge of the fastener body and configured to be inserted into the second longitudinal slot, the second rail having at least one protrusion for engaging an interior surface of the second longitudinal slot, thereby retaining the second rail in the second longitudinal slot.

30. The system of claim 29, wherein the seam of the second insulation wrap is rotationally offset from the seam of the first insulation wrap.

31. The system of claim 20, further comprising a barrier layer disposed around the first insulation wrap.
